(19) United States
(12) Patent Application Publication
(10) Pub. No.: US 2025/0018970 A1
(43) Pub. Date: Jan. 16, 2025

(54) HIERARCHICAL EDGE COMPUTE FOR AUTONOMOUS SYSTEMS AND APPLICATIONS

(71) Applicant: NVIDIA Corporation, Santa Clara, CA (US)

(72) Inventors: Balaji HOLUR, Sunnyvale, CA (US); Robin JENKIN, Morgan Hill, CA (US)

(21) Appl. No.: 18/516,095

(22) Filed: Nov. 21, 2023

Related U.S. Application Data
(60) Provisional application No. 63/526,826, filed on Jul. 14, 2023.

(51) Int. Cl. B60W 60/00; G08G 1/01; G08G 1/16

(52) U.S. Cl. CPC B60W 60/001; G08G 1/012; G08G 1/164; B60W 2420/403; B60W 2556/45

(57) ABSTRACT

Embodiments of the present disclosure may include a method and system for navigating one or more environments using hierarchical edge computing. In some embodiments, the method may include sending location data to an edge server, where, in some embodiments, the location data may indicate a location of the ego-machine and path data that may indicate a planned path through a portion of an environment that may correspond to the ego-machine. Further, in some embodiments, the method may additionally include receiving a notification from the edge server associated with the planned path. In some embodiments, the notification is based on a comparison between the planned path to one or more learned paths. Additionally or alternatively, in some embodiments, the method may additionally include navigating the ego-machine through the portion of the environment based on the received notification.

### CROSS-REFERENCE TO RELATED APPLICATION

This patent application claims the benefit of and priority to U.S. Provisional App. No. 63/526,826 filed Jul. 14, 2023, titled “HIERARCHICAL EDGE COMPUTE TO ENHANCE SAFETY AND PATH PLANNING FOR AUTONOMOUS SYSTEMS AND APPLICATIONS,” the contents of which are incorporated herein by reference in their entirety.

### BACKGROUND

Systems and machines-such as autonomous and semi-autonomous machines—may determine, generate, and/or follow one or more paths based on data collected and/or generated in an environment. In some instances, ego-machines may determine and/or generate planned paths to navigate through an environment. For example, in the context of an ego-machine as a vehicle, the vehicle may determine and/or generate a path to follow from a first position to a second position corresponding to the environment.

In many instances, autonomous and/or semi-autonomous machines approach each portion of an environment (e.g., a portion of a roadway for an autonomous vehicle) as if seeing it for the first time, regardless of the number of times the environment has been historically travelled. Furthermore, in the context of vehicles travelling on a particular stretch of road, thousands of vehicles may traverse the particular stretch of road or junction in a single day and perhaps millions per year. During its traverse, respective vehicles may trace a path through a particular section of road or junction based on road markings and traffic signage, road layout, current obstacles or actors in the environment, etc. A human driver may quickly learn expected trajectories through these sections of road based on familiarity with the road, similar roads, traffic flow, etc. However, for autonomous and/or semi-autonomous vehicles, this a posteriori information generated by vehicles that previously traversed the location is not available as a priori information to new vehicles entering the section of road. Some existing systems may perform error checking offline to evaluate paths, planning, or behaviors of autonomous or semi-autonomous machines, but do not take advantage of any learned behaviors in real-time or near real-time. As such, the ability for a vehicle to leverage this prior information to make real-time decisions is not currently available, and thus this additional information is wasted in the path planning and behavior decisions of vehicles during navigation.

### SUMMARY

Embodiments of the present disclosure relate to hierarchical edge compute for autonomous and semi-autonomous systems and applications. Systems and methods are disclosed that aggregate actual vehicle paths and speeds in edge servers to build expected vehicle paths or learned vehicle paths, speeds, and time window probabilities for sections of roads and/or junctions. As such, when traversing a section of a road or junction, a vehicle and/or the edge server may then compare the vehicle's computed path with the stored path probabilities and, if the vehicle path or speed deviates from an expected path, precautionary actions may be triggered-such as modifying the behavior of the vehicle, deploying safety measures, recomputing a trajectory for the vehicle, uploading local images for further processing, etc.

In some embodiments, prior vehicle paths and speeds may be aggregated from local vehicle data and/or using cameras and/or other surveillance equipment-such as in a smart cities system-monitoring the particular road or junction. Encompassed in this is the concept of hierarchical decision making and control for autonomous or semi-autonomous vehicles, where local vehicle-based decisions (Level 1) are tested against edge server (Level 2) logic and further both against data center (Level 3) or higher logic if necessary, allowing for software defined behavior plasticity.

Embodiments of the present disclosure may include a method and/or system for navigating an environment and/or a portion of an environment. In some embodiments, the method and/or system may include sending, to an edge server, location data that may indicate a location of a machine and path data that may indicate a planned path through a portion of an environment. In some embodiments, the method may additionally include receiving a notification from the edge server, where the notification may be associated with the planned path of the machine. In some embodiments, the notification may be based on the comparison of the planned path to one or more learned paths, where the one or more learned paths may be determined using the edge server. In some embodiments, the one or more learned paths may be determined based on one or more successfully navigated past paths of one or more other machines through the portion of the environment. In some embodiments, the method may further include navigating the machine through the portion of the environment based on the received notification.

Safety is of critical importance with respect to autonomous and semi-autonomous navigation, and the systems and methods described herein compare behavior and/or planned behavior(s) associated with a machine to learned or expected behavior—learned from historical navigation of any number of machines—to provide an additional level of checks and balances in real-time or near real-time at the edge. These systems and methods thus provide a hierarchical, software-defined evolution of machines over time, and increases the safety and path planning of autonomous and semi-autonomous systems.

### BRIEF DESCRIPTION OF THE DRAWINGS

The present disclosure includes systems and methods for hierarchical edge compute for autonomous or semi-autonomous systems and applications, wherein:

FIG. 1A illustrates a flow diagram for a process of navigating a particular environment based on one or more notifications corresponding to an edge server, in accordance with one or more embodiments of the present disclosure;

FIG. 1B illustrates an example environment illustrating a number of lanes through which one or more vehicles may travel, in accordance with one or more embodiments of the present disclosure;

FIG. 1C is a diagram illustrating an environment including a number of learned paths through a particular junction, in accordance with one or more embodiments of the present disclosure;

FIG. 2 illustrates an environment including an edge server configured to generate learned path data corresponding to one or more learned paths, in accordance with one or more embodiments of the present disclosure;

FIG. 3 illustrates an environment including a machine configured to compare one or more planned paths against notification data, in accordance with one or more embodiments of the present disclosure;

FIG. 4 is a flow diagram showing a method for navigating one or more machines through a portion of an environment based on learned path data corresponding to an edge server, in accordance with one or more embodiments of the present disclosure;

FIG. 5A is an illustration of an example autonomous vehicle, in accordance with one or more embodiments of the present disclosure;

FIG. 5B is an example of camera locations and fields of view for the example autonomous vehicle of FIG. 5A, in accordance with one or more embodiments of the present disclosure;

FIG. 5C is a block diagram of an example system architecture for the example autonomous vehicle of FIG. 5A, in accordance with one or more embodiments of the present disclosure;

FIG. 5D is a system diagram for communication between cloud-based server(s) and the example autonomous vehicle of FIG. 5A, in accordance with one or more embodiments of the present disclosure;

FIG. 6 is a block diagram of an example computing device suitable for use in implementing one or more embodiments of the present disclosure; and

FIG. 7 is a block diagram of an example data center suitable for use in implementing one or more embodiments of the present disclosure.

### DETAILED DESCRIPTION

Systems and machines-such as, for example, ego-machines—may determine, generate, and/or follow one or more paths or trajectories based on data collected and/or generated in an environment. In some instances, ego-machines (e.g., autonomous or semi-autonomous vehicles or machines) may determine and/or generate planned paths to navigate through an environment. For example, in the context of an ego-machine as a vehicle, the vehicle may determine and/or generate a path to follow from a first position to a second position corresponding to a particular stretch of road, a particular junction, etc. As used herein, reference to a “path” may include a position and/or position data indicating the position—e.g., past, present, or future—corresponding to a machine. In these and other embodiments, the path may represent or indicate navigation of the machine within a portion of the environment.

In some embodiments, the position data corresponding to the path may be two-dimensional. For example, with respect to a vehicle navigating a particular stretch of road, the corresponding position data may correspond to the ground plane. Additionally or alternatively, the position data corresponding to the path may be three-dimensional (“3D”). For example, with respect to a drone navigating a particular volume, the position data may correspond to a position along the ground plane as well as elevation.

As used herein, reference to a particular portion of the environment may include a discrete volume associated with a larger environment. For example, in the context of autonomous vehicles, a portion of the environment may be a junction and/or a particular stretch of road where a start and end may be clearly defined. As an additional example, in the context of industrial robotics, the particular portion of the environment may refer to navigating from one portion of the jobsite, construction zone, warehouse, etc. to a second portion of the jobsite, construction zone, warehouse, etc.

In some embodiments, the one or more paths used to navigate through the particular portion of the environment may be generated and/or determined based on data generated, collected, and/or otherwise obtained using one or more sensors corresponding to the ego-machine. For example, in the context of an autonomous vehicle, a path may be determined based on data generated using one or more light detection and ranging (LiDAR) sensors, radio detection and ranging (RADAR) sensors, image sensors, etc.

Additionally or alternatively, in some instances, other data may be used, such as, for example, map data corresponding to a map and/or data generated using one or more other machines, such as, for example, past path data corresponding to other machines that may have navigated the particular portion of the environment, data corresponding to construction or events that may affect the determined path, data corresponding to weather conditions, time of day, time of year, traffic, etc. In some instances, both data generated using one or more sensors corresponding to the ego-machine and/or other data corresponding to the environment and/or the portion of the environment may be used by the ego-machine to navigate the particular portion of the environment successfully.

One or more embodiments of the present disclosure may relate to machines navigating an environment and/or portions of an environment based on past data indicating past paths of other machines through the environment and/or portions of the environment. In some embodiments, a machine may navigate a particular portion of an environment based on data transmitted or communicated to the ego-machine via one or more other systems, servers, data centers, etc. In some embodiments, the data may include one or more notifications that may have been generated based on past path data corresponding to past paths used to successfully navigate the portion of the environment by one or more other machines. In some embodiments, the one or more notifications may be communicated to the ego-machine based on whether the planned path determined and/or generated by the ego-machine may be different from the one or more past paths used by one or more other machines to successfully navigate the portion of the environment.

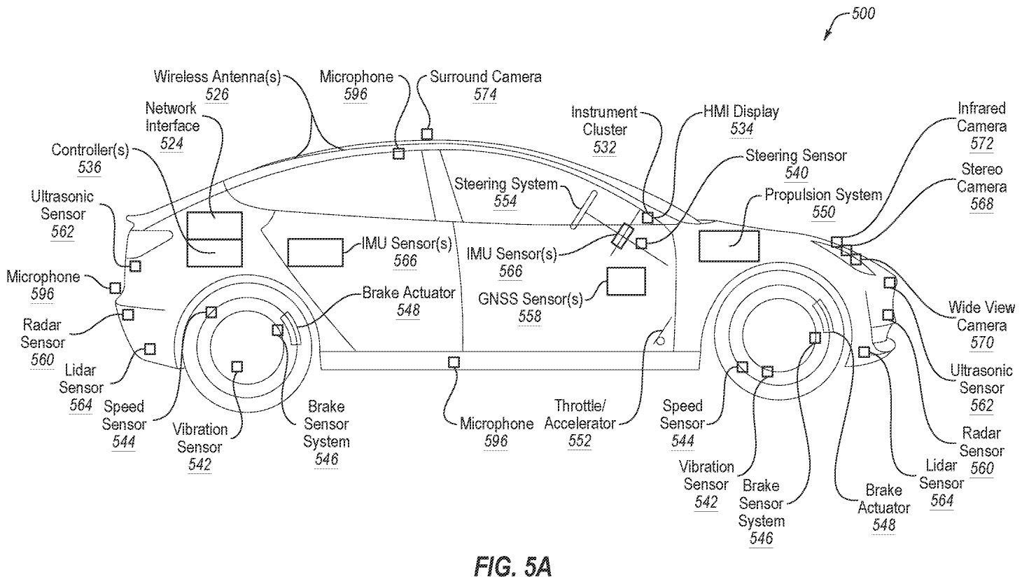

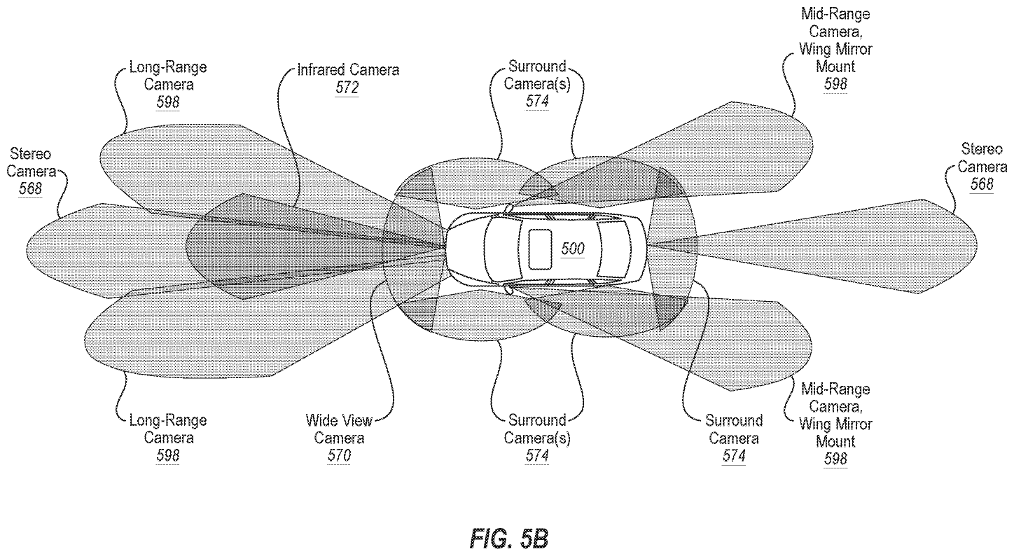

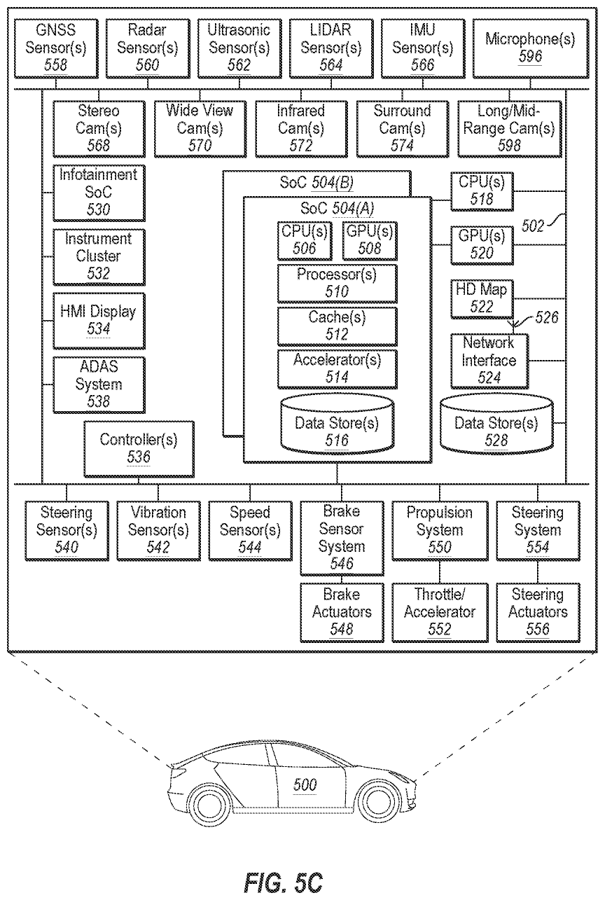

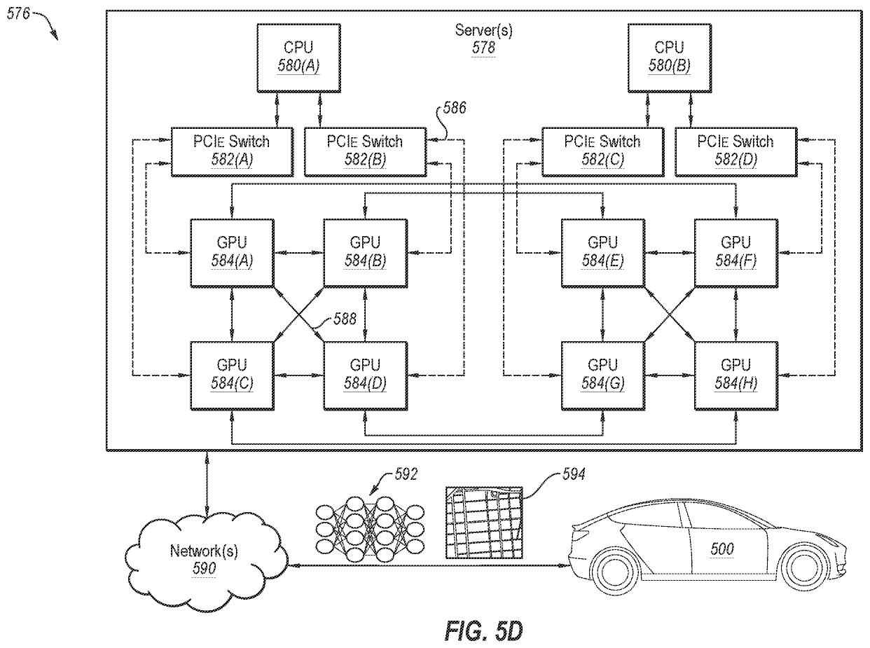

One or more of the embodiments disclosed herein may relate to one or more machines navigating an environment or a portion of the environment using learned path data, where the one or more machines may include ego-machines which may include any applicable machine or system that is capable of performing one or more autonomous and/or semi-autonomous operations. Example ego-machines may include, but are not limited to, vehicles (land, sea, space, and/or air), robots, robotic platforms, etc. By way of example, the ego-machine computing applications may include one or more applications that may be executed by an autonomous vehicle or semi-autonomous vehicle, such as an example autonomous or semi-autonomous vehicle or machine 500 (alternatively referred to herein as “vehicle 500” or “ego-machine 500) described with respect to FIGS. 5A-5D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems that implement one or more language models, such as one or more large language models (LLMs) that process textual, audio, image, sensor, and/or other data types to generate one or more outputs, systems for hosting real-time streaming applications, systems for presenting one or more of virtual reality content, augmented reality content, or mixed reality content, systems for performing light transport simulation, systems for performing collaborative content creation for 3D assets, systems for performing one or more generative AI operations, systems implemented at least partially using cloud computing resources, and/or other types of systems.

As described herein, thousands of vehicles may traverse a particular junction or section of road (or warehouse, building, waterway, etc. sections or areas) every day, each one tracing out a trajectory having successfully negotiated that portion of its journey. These trajectories are based on the road or junction layout, traffic signage and marks, time of day, weather conditions, temporary restrictions and roadworks, current object and traffic information, etc., and represent a rich information source on how to successfully and safely negotiate that particular section of road or junction. In addition, unsuccessful traversal of road sections or junctions (or warehouse, building, waterway, etc. sections or areas) may also occur, and valuable information may be learned from these traversals.

However, this information is lost to, for example, vehicles entering that section of road or junction in which autonomous or semi-autonomous vehicles may effectively approach the road as if seeing it for the first time. In some embodiments, communicating between one or more vehicles and one or more edge servers located nearby a particular environment may help facilitate real-time or near real-time transmission and comparison of computed ego-vehicle trajectories or “planned paths” with expected path probabilities and/or speeds or “learned paths” for that section of road or junction. The one or more learned paths may be compiled from successful and/or unsuccessful navigation of the road or junction and may be aggregated by time of day, weather conditions, lighting conditions, road conditions, traffic conditions, year, and/or based on other characteristics associated with the collected information. Further, temporary deviations of paths and speeds can be computed to account for traffic, construction, obstacles, other restrictions, etc. In some embodiments, in response to an ego-vehicle deviating from the one or more learned paths, alerts and precautionary actions may be triggered to enhance safety and/or path planning. In order to facilitate low latency of transmission and comparison, the comparison between one or more learned paths and one or more planned paths may be performed using one or more edge servers. In some embodiments, using one or more edge servers to perform the comparison may reduce the computation time, memory, and communication bandwidth needs of the ego-vehicle.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

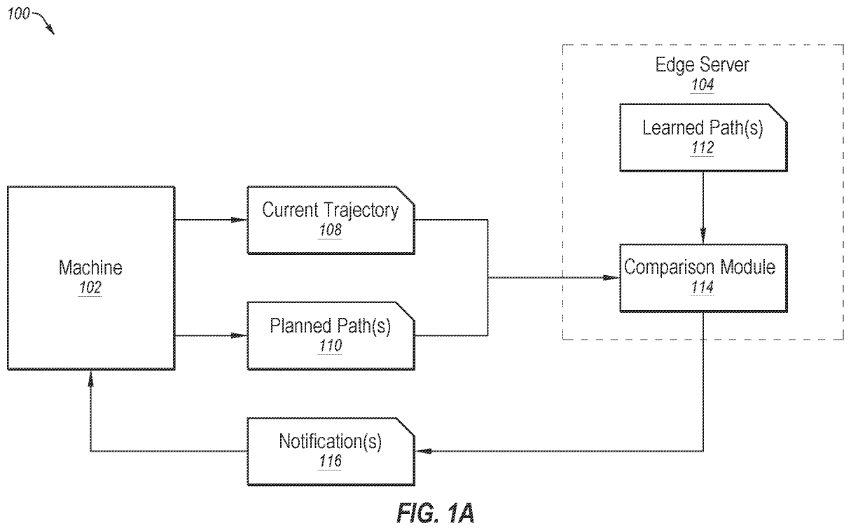

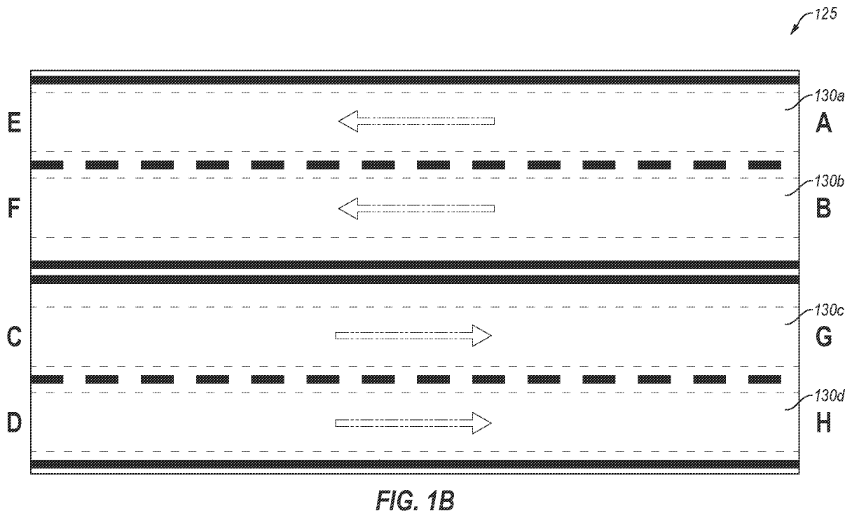

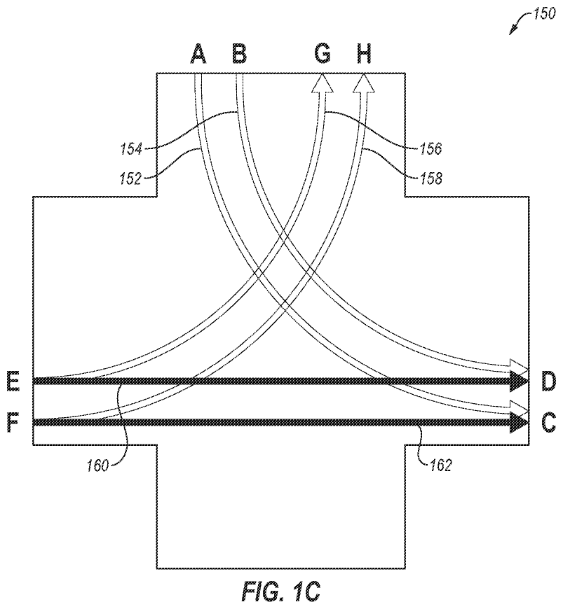

Now referring to FIG. 1A, FIG. 1A illustrates a flow diagram 100 for a process of navigating a particular environment based on one or more notifications 116 obtained using an edge server 104, in accordance with one or more embodiments of the present disclosure. In some embodiments, the environment 100 may include a machine 102 that may be configured to navigate a particular portion of an environment. Further, in some embodiments, the portion of the environment through which the machine 102 may navigate, may be located in close proximity relative to a particular edge server 104. For example, the edge server 104 may be within a particular radius of the portion of the environment (e.g., 5 miles, 10 miles, 20 miles, etc.) In some embodiments, the edge server 104 and the machine 102 may communicate such that the machine 102 may successfully navigate the portion of the environment.

In some embodiments, the machine 102 may include one or more systems, robots, vehicles, drones, equipment, etc. that may be configured to travel from one position to another. For example, the machine 102 may include one or more drones, robots, industrial robots, boats, cars, trucks, other vehicles, ego-machines, etc. In some embodiments, travelling from one location to another may include travelling from one position on a ground plane to a second position on the ground plane. Additionally or alternatively, travelling from one location to another may include the machine 102 traveling through a particular volume from a first position and elevation to a second position and elevation.

In some embodiments, the machine 102 may be configured to generate information corresponding to the environment that may be used by the machine 102 to traverse the environment and/or a portion of the environment (e.g., from a first position to a second position). In some embodiments, for example, the machine 102 may include one or more sensors (e.g., image sensors, position sensors, accelerometers, gyroscopes, rotational speed sensors, etc.) that may generate data corresponding to the environment. For example, the machine 102 may include one or more cameras that may collect and/or generate image data corresponding to the environment. Continuing the example, the machine 102 may be configured to use the image data generated using the one or more corresponding sensors to navigate from a first portion of the environment to a second portion of the environment. While the example uses image data, the use of image data is not meant to be limiting; for example, the machine 102 may include one or more other sensors, such as, for example, one or more RADAR sensors, LiDAR sensors, sound navigation and ranging (“SONAR”) sensors, infrared sensors, and/or other sensors that may generate sensor data corresponding to the portion of the environment in which the machine 102 may be located.

In some embodiments, the machine 102 may be configured to communicate with one or more other machines, systems, subsystems, etc. to receive information corresponding to the environment. For example, one or more systems outside of the machine 102 may be configured to transmit and/or otherwise communicate data and/or information associated with the environment in which the machine 102 may be located. For example, one or more other systems may be configured to generate weather data, temperature data, humidity data, etc. corresponding to the environment or a portion of the environment. In some embodiments, the machine 102 may be configured to receive that information from one or more other sources, systems, devices, machines, etc. Continuing the example, the machine 102 may be configured to adapt and/or change one or more control commands based on the data and/or information that may have been received from one or more other systems (e.g., alter one or more paths through the environment, decelerate, turn, change lanes, perform one or more evasive maneuvers, etc.).

In some embodiments, the machine 102 may be configured to generate planned path data corresponding to one or more planned paths 110 corresponding to the machine 102 traversing a particular portion of the environment. In some embodiments, the one or more planned paths 110 may include a position and/or position data indicating the position—e.g., past, present, or future-corresponding to the machine 102. In these and other embodiments, the path may represent or indicate navigation of the machine 102 within a portion of the environment.

In some embodiments, the one or more planned paths 110 may indicate the intended navigation of the machine 102 through the particular portion of the environment. In some embodiments, the granularity with which the machine 102 may plan its trajectory may depend on localization capabilities associated with the machine 102. For example, in the context of the machine 102 as an autonomous vehicle, the machine 102 may be configured to determine a path where the machine 102 may generally stay within a particular traffic lane. By comparison, the machine 102 may determine a more granular path, such as, for example, determining where the tires of the machine 102 may be located on the road within one or more particular lanes. For example, the machine 102 may have located a pothole on the left-most portion of the lane. Continuing the example, the machine 102 may determine a path within the lane to avoid the pothole.

In some embodiments, the one or more planned paths 110 may include only position data corresponding to the machine 102. For example, the one or more planned paths 110 may indicate where the machine 102 may be at a given future time. In some embodiments, the planned paths 110 may additionally include intended orientation data, velocity data, acceleration data, jerk data, and/or data corresponding to one or more other intended movement characteristics associated with the machine 102. In some embodiments, the velocity, acceleration, etc. may be deduced and/or otherwise determined from the position data that may be associated with the one or more planned paths 110.

In some embodiments, the machine 102 may additionally be configured to generate and/or determine a current trajectory 108, where the current trajectory 108 may include one or more movement characteristics associated with the machine 102. For example, the current trajectory 108 may include a position, velocity, acceleration, etc. corresponding to the machine 102 at one or more current time stamps. In some embodiments, the current trajectory 108 may additionally include localization data associated with the machine 102. For example, the current trajectory 108 may include the location and/or orientation of the machine 102 along with the position, velocity, acceleration, etc. at a particular time stamp.

In some embodiments, the machine 102 may be configured to send, transmit, and/or otherwise communicate the planned path data corresponding to one or more planned paths 110 and/or data corresponding to the current trajectory 108 to the edge server 104. In some embodiments, the edge server 104 may be configured to receive data and/or otherwise obtain information from the machine 102 such as, for example, data corresponding to the current trajectory 108 and/or the planned paths 110.

In some embodiments, the edge server 104 may include one or more computing servers, computing networks, etc. that may be more local to where data may be generated, processed, or consumed as compared to one or more cloud computing servers that may be located further from the physical location where data may be generated, processed, and/or consumed. In some embodiments, the edge server 104 may be located closer to the portion of the environment that may correspond to the planned path data than, for example, one or more central servers, data centers, cloud servers, etc. For example, in the context of the portion of the environment through which the machine 102 may travel being a particular stretch of road, the edge server 104 may be located within a particular radius of the particular stretch of road (e.g., within a 5-mile radius, within a 10-mile radius, within a 20-mile radius, etc.).

In some embodiments, the edge server 104 may include memory, processing units, computing hardware, etc. that may be configured to perform one or more operations corresponding to obtained data and generate one or more notifications 116 and/or data corresponding to the one or more notifications 116 based on the received data.

In some embodiments, the edge server 104 may be configured to communicate data and/or information to the machine 102 faster than one or more other central and/or cloud servers. In some embodiments, because the edge server 104 may be physically closer to the machine 102 as compared with one or more cloud servers or other central servers, the distance for transmitting planned path data corresponding to one or more planned paths 110 may be shorter than the distance for transmitting planned path data corresponding to one or more planned paths 110 to one or more central servers. As a result, the time needed to transmit the planned path data between the machine 102 and the edge server 104 may be less than the time to transmit the planned path data from the machine 102 to one or more central servers, cloud servers, etc. Further, using the edge server 104 may reduce network congestion by handling data transfer (e.g., planned path data transfer) closer to the machine 102. In some embodiments, using the edge server 104 may reduce a likelihood that planned path data may be delayed or lost due to network congestion as compared with transmitting the planned path data to one or more central servers that may be more likely to be congested. In some embodiments, as a result, using the edge server 104 to communicate with the machine 102 may reduce latency and/or improve response times as compared with the machine 102 communicating with one or more data centers, centralized servers, cloud servers, etc.

In some embodiments, the edge server 104 may be configured to collect, receive, and/or otherwise obtain information corresponding to the particular portion of the environment. In some embodiments, the edge server 104 may be configured to generate learned path data corresponding to one or more learned paths 112 based on data associated with the portion of the environment. As used herein, one or more learned paths 112 may include and/or refer to learned path data—e.g., data corresponding to and/or defining the one or more learned paths 112. Further, reference to one or more learned paths 112 may refer to using, transmitting, comparing, and/or otherwise manipulating learned path data associated with the one or more learned paths 112. In some embodiments, the edge server 104 may include one or more modules—e.g., a comparison module 114 to compare the learned paths 112 with the planned paths 110 and/or the current trajectory 108 associated with the machine 102.

For example, in the context of an environment including a stretch of road, the edge server 104 may be close in proximity to a particular junction. Continuing the example, one or more machines that may have navigated the particular junction may transmit path data corresponding to one or more paths that may have been taken by the one or more machines through the particular junction. Further continuing the example, the edge server 104 may be configured to determine and/or generate learned path data corresponding to one or more learned paths 112 through the particular junction based on the past path data corresponding to one or more past paths that may have been transmitted by the one or more machines. Stated differently, the edge server 104 may be configured to generate one or more paths and corresponding probabilities associated with the one or more paths. In some embodiments, the probabilities may indicate a likelihood that a machine may take a particular path to navigate the particular junction. For example, in the context of autonomous or semi-autonomous vehicles navigating a particular junction, the learned path data corresponding to the one or more learned paths 112 may indicate that a vehicle with a particular starting location may, with a first probability, take a first path to navigate the particular junction. Additionally or alternatively, the learned path data may indicate that the vehicle with the particular starting location may, with a second probability, take a second path to navigate the particular junction, and so on.

In some embodiments, the one or more learned paths 112 may be generated based on path data received from one or more ego-machines. For example, in the context of autonomous vehicles, autonomous vehicles navigating the portion of the environment may transmit and/or communicate path data corresponding to the path taken through the portion of the environment to the edge server 104. Additionally or alternatively, one or more other sensors and/or machines may determine position data corresponding to one or more machines navigating the portion of the environment. For example, one or more cameras may be placed atop one or more poles (e.g., light poles, traffic signals, etc.) corresponding to a particular junction. The cameras and one or more associated processing systems may be configured to determine position data corresponding to the one or more machines navigating the junction. The path data corresponding to the one or more machines may be communicated to the edge server 104 which may use, store, and/or access the path data to determine one or more learned paths 112 corresponding to the junction.

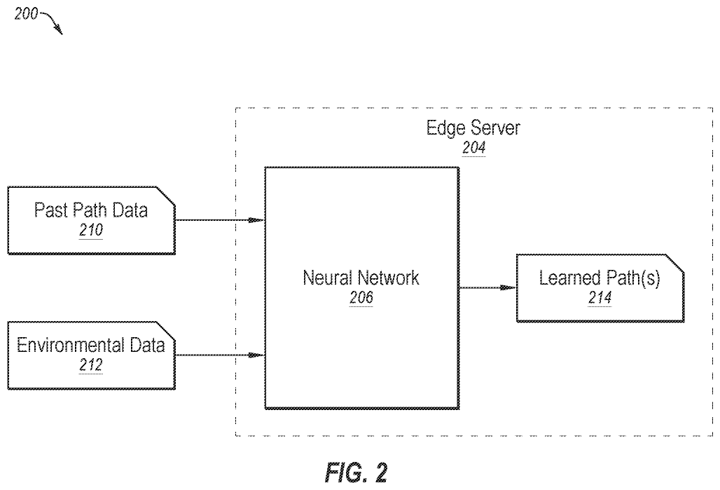

In some embodiments, the learned paths 112 may be determined using one or more machine learning models, neural networks, deep neural networks, and optimization algorithms that may be configured to receive path data corresponding to past paths of machines and generate corresponding probabilities that a particular machine may take a particular path through the portion of the environment. Additionally or alternatively, the one or more learned paths 112 may be determined based on one or more past machines successfully traversing the portion of the environment corresponding to the edge server 104. In some embodiments, determining one or more learned paths 112 may be described and/or illustrated further in the present disclosure, such as, for example, with respect to FIG. 2.

In some embodiments, “successfully navigated” may indicate that a machine may have traversed the portion of the environment from a first point to a second point in a period of time without a significant incident. The period of time determined based on a multiple of the mean amount of time it takes one or more machines to traverse the portion of the environment. For example, the period of time may be two-times the mean (or median, or mode, etc.), three-times the mean, four-times the mean, etc. Additionally or alternatively, the period of time may include a standard deviation of the total distributions of paths corresponding to the particular portion of the environment. In some embodiments, the mean amount of time taken to traverse the portion of the environment may be based on the time of day, time of year, weather conditions, environmental conditions, type of machine (e.g., motorbike, truck, car, drone, industrial robot, etc.).

For example, a particular junction corresponding to the edge server 104 may be traversed in a first amount of time during the summer with clear conditions. In another example, the particular junction may be traversed in a second amount of time during the winter with snowy conditions, the second amount of time may be different from the first amount of time. As such, an amount of time given to consider a traversal of the particular portion of the environment “successful” may be context dependent.

In some embodiments, a significant incident may refer to a particular event or circumstance where an amount of risk to the passengers, machine, other property, and/or persons may have increased beyond an acceptable threshold. For example, a machine may not be considered to have successfully navigated the portion of the environment if an accident occurred that may have included the machine, even if the machine traverses the portion of the environment within the defined period of time. As an additional example, in the context of a vehicle, the vehicle may increase its speed and drive on a shoulder of the road to traverse a particular portion of the environment. However, because this may be increasing the risk of the passengers, the vehicle, other vehicles, other persons on the road, other property, etc. above a particular threshold, the vehicle may not be considered to have successfully traversed the particular environment and/or the vehicle may be considered as traversing the environment “unsuccessfully.”

In some embodiments, the risk threshold may be based on one or more heuristic analyses. For example, the one or more heuristic analyses may indicate that performing certain operations is correlated with a higher number of accidents, mechanical failures, evasive maneuvering, etc. Additionally or alternatively, the risk threshold may be based on traffic rules and regulations and typical norms and behavior of the travelling medium. The risk threshold may be different for drones or industrial robots as compared with autonomous or semi-autonomous vehicles driving on the road. For example, in the context of an autonomous vehicle navigating a particular stretch of highway, the risk threshold may be based on traffic rules and regulations generally applicable to vehicles on the highway and/or local rules and norms corresponding to the particular stretch of highway (e.g., speed limits, using the left lane to pass other vehicles, using a turn indicator for a particular distance and/or amount of time prior to changing lanes, etc.). By contrast, the risk threshold corresponding to an industrial robot may be based on rules the pertain to a particular site (e.g., distance between machines, avoiding dangerous portions of the site, etc.).

In some embodiments, the learned paths 112 may be generated and/or determined based on an initial position corresponding to one or more machines that may be traversing the portion of the environment. For example, in the context of autonomous vehicles, the portion of the environment may correspond to a particular stretch of road including several miles of a four-lane road. In some embodiments, a first vehicle may begin navigating the particular stretch of road in a first lane, the most likely path taken by the first vehicle to navigate the particular stretch of road may be remaining in the first lane. Some vehicles may deviate and navigate the particular stretch of road in a second lane, a third lane, or a fourth lane. However, the one or more learned paths 112 determined using the path data may indicate that a vehicle beginning to navigate the particular stretch of road in the first lane, will most likely remain in the first lane. Correspondingly, a second vehicle may begin navigating the particular stretch of road in the second lane where is may be most common to remain in the second lane, and so on. Another example embodiment of one or more learned paths 112 that may be generated corresponding to one or more initial positions may be illustrated with respect to FIG. 1B.

FIG. 1B illustrates an example environment 125 illustrating a number of lanes 130 through which one or more vehicles may travel, in accordance with one or more embodiments of the present disclosure. In some embodiments, the environment 125 may include a portion of the environment with which the edge server 104 may be associated. As illustrated in FIG. 1B, the portion of the environment may include a simple straight section of two-lane contraflow road. In some embodiments, the environment 125 may include a number of potential paths that may be taken by a machine travelling from one location to another, where the one or more paths may coincide with one or more of the driving lanes 130.

The driving lanes 130 may include a first lane 130a where vehicles may travel from a first location ‘A’ to a second location ‘E’ and a second lane 130b where vehicles may travel from a first location ‘B’ to a second location ‘F.’ Additionally or alternatively, the environment 125 may include a third lane 130c where vehicles may travel from a first location ‘C’ to a second location ‘G’ and a fourth lane 130d where vehicles may travel from a first location ‘D’ to a second location ‘H.’

In some embodiments, the one or more learned paths 112 corresponding to the edge server 104 may include vehicles travelling in one lane and in one direction. Additionally or alternatively, the one or more learned paths 112 may include vehicles changing lanes; for example, from the first lane 130a to the second lane 130b and/or from the third lane 130c to the fourth lane 130d and so on. In some embodiments, the one or more learned paths 112 may indicate that, in the environment 125, a vehicle travelling from ‘A’ to ‘E’ or ‘A’ to ‘F’ may not do so in the third lane 130c or the fourth lane 130d. The edge server 104 may determine this based on the very low probability that a vehicle may travel from ‘A’ to ‘E’ in the wrong direction. Additionally or alternatively, the edge server 104 may determine that travelling from a first location ‘B’ to a second location ‘C’ may not be considered a successful traversal of the portion of the environment based on an increased amount of risk to the passengers, the vehicle, other vehicles, etc.

In some embodiments, the amount of time, the speed, the acceleration, etc. corresponding to each of the vehicles travelling through the environment 125 may be monitored. In some embodiments, the edge server 104 may be configured to determine an average amount of time it takes for a vehicle to travel, for example, from ‘A’ to ‘E’ in the first lane 130a and/or from ‘A’ to ‘F’ from the first lane 130a to the second lane 130b, etc. In some embodiments, the position and speed of each vehicle travelling through the environment 125 is represented as time series data between the time the vehicle enters and exits the environment 125. In some embodiments, such as where speed data is not available, the speed information may be determined from position data.

In some embodiments, using the speed data and/or position data, the edge server 104 may be configured to determine an amount of time for another machine (e.g., the machine 102) to successfully traverse the environment 125 from a first position to a second position.

Modifications, additions, or omissions may be made to FIG. 1B without departing from the scope of the present disclosure. For example, the environment 125 may vary—e.g., the environment 125 may include one or more different number of lanes 130, different stretches of road, different junctions, etc. Further, the environment 125 may include one or more volumes or other discrete spaces through which one or more machines may travel. The specifics given and discussed are to help provide explanation and understanding of concepts of the present disclosure and are not meant to be limiting.

Returning to the description of FIG. 1A, in addition to the number of paths that may be included in the learned paths 112, the one or more learned paths 112 may be generated and/or determined based on a particular time period within which the past path data may have been generated and/or collected. For example, in the context of the particular stretch of a four-lane road, path data collected or otherwise obtained by the edge server 104 corresponding to one-year prior to a current time may indicate a first set of probabilities corresponding to paths that may be taken by one or more machines. However, one-month prior to the current time, construction may have begun where the four-lane road may transition to a two-lane road somewhere in the particular stretch of the four-lane road. The one or more learned paths 112 corresponding to past path data generated up to one-month prior to the current time may differ significantly from the one or more learned paths 112 corresponding to past path data generated over one month prior to the current time due to the construction.

In some embodiments, the one or more learned paths 112 may be segmented based on time. For example, the edge server 104 may be configured to generate one or more learned paths 112 based on all of the path data obtained over time. Additionally or alternatively, the edge server 104 may be configured to weigh the one or more learned paths 112 based on one or more time segments. For example, one or more learned paths 112 may segmented in the last minute, hour, day, month, year, five years, all time, etc. Furthermore, in some embodiments, the one or more learned paths 112 corresponding to more recent path data may be weighted more heavily than path data corresponding to more distant past path data. The assumption behind weighting the path data in this manner may be that the more recent path data may generate one or more learned paths 112 that may be more effective in assisting one or more current machines (e.g., the machine 102) in navigating the portion of the environment than one or more learned paths 112 corresponding to more distant past path data.

In some embodiments, the one or more learned paths 112 may be generated based on absolute time. In some embodiments, the one or more learned paths 112 may indicate one or more different paths through a particular portion of the environment that may not be taken at the same time. For example, in the context of autonomous vehicles, a vehicle may not turn left through an intersection at the same time that another vehicle is travelling straight through the intersection. In some embodiments, for example, an analysis may be performed by clustering the time series and position data to identify the expected routes that a machine may take through the portion of the environment. In some embodiments, once the one or more learned paths 112 are identified, further analysis may be performed to identify whether one or more learned paths 112 may be travelled at the same time.

An example of one or more learned paths 112 indicating various paths that may be taken through a particular junction may be illustrated with respect to FIG. 1C, FIG. 1C is a diagram illustrating an environment 150 illustrating a number of learned paths through a particular junction, in accordance with one or more embodiments of the present disclosure.

In some embodiments, the environment 150 may include a first path 152 travelling from ‘A’ to ‘C’, a second path 154 from ‘B’ to ‘D’, a third path 156 from ‘E’ to G′, a fourth path 158 from ‘F’ to ‘H’, a fifth path 160 ‘E’ to ‘D’, and a sixth path 162 from ‘F’ to ‘C.’ In some embodiments, in response to the edge server 104 determining the one or more learned paths (e.g., the one or more learned paths 112) travelling through the environment 150, the edge server 104 may be configured to analyze and label each of the learned paths at the junction, and the actual start and stop times of each of the learned paths is then used to identify when each path may coexist with another path. For example, as illustrated in FIG. 1C, vehicles traveling from A and B to C and D may not travel at the same time as cars from E and F to G and H or D and C as the traffic crosses—e.g., due to left turns, in this example. The example in FIG. 1C shows that the start to stop times of routes AC and BD do not overlap with routes EG, FH, ED, or FC.

Modifications, additions, or omissions may be made to FIG. 1C without departing from the scope of the present disclosure. For example, the environment 150 may vary—e.g., the environment 150 may include one or more different number of paths, different types of junctions, etc. Further, the environment 150 may include one or more volumes or other discrete spaces through which one or more machines may travel. The specifics given and discussed are to help provide explanation and understanding of concepts of the present disclosure and are not meant to be limiting.

Returning to the description of FIG. 1A, the edge server 104 may be configured to compare the one or more learned paths 112 with data corresponding to the machine 102—e.g., the one or more planned paths 110 and/or the current trajectory 108. In some embodiments, the edge server 104 may include one or more systems, subsystems, modules, etc. that may be configured to compare the one or more learned paths 112 with the past paths 110 and/or the current trajectory 108—for example, using the comparison module 114. As used herein, reference to comparing the past paths 110 and/or current trajectory 108 with one or more learned paths 112 may include comparing all of and/or a portion of the past path data corresponding to the past paths 110, the current trajectory data associated with the current trajectory 108, and/or the learned path data corresponding to the one or more learned paths 112.

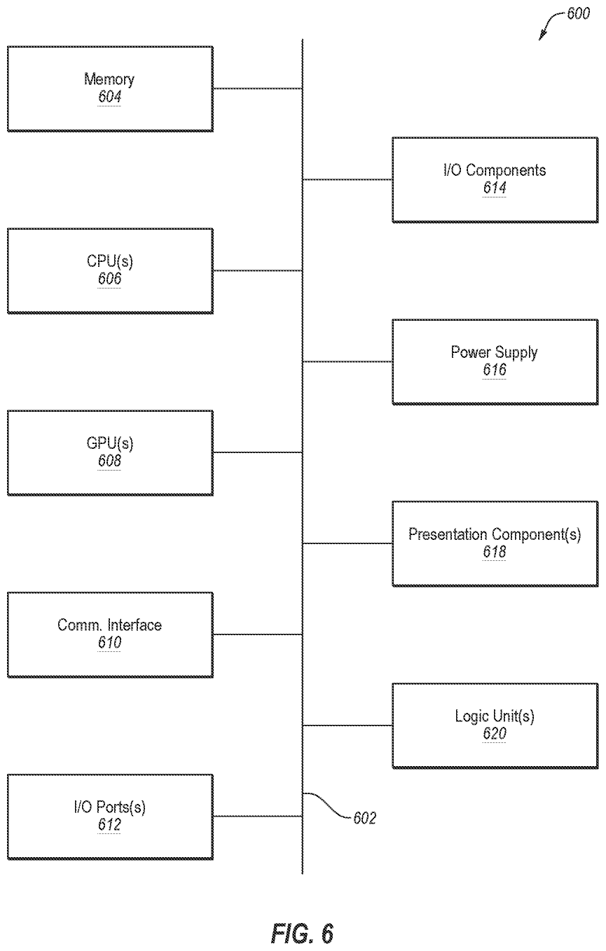

In some embodiments, the comparison module 114 may include code and routines configured to allow a computing system to perform one or more operations. Additionally or alternatively, the comparison module 114 may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, the comparison module 114 may be implemented using a combination of hardware and software. In the present disclosure, operations described as being performed by the comparison module 114 may include operations that the comparison module 114 may direct a corresponding computing system to perform. In these or other embodiments, the comparison module 114 may be implemented by one or more computing devices, such as that described in further detail with respect to FIGS. 5A-5D, 6, and/or 7.

In some embodiments, the comparison module 114 may be configured to compare data and/or information that may have been received from the machine 102 with the one or more learned paths 112 corresponding to the portion of the environment. In some embodiments, the comparison may yield some similarity between the one or more learned paths 112 and the planned path 110. In some embodiments, for example, the comparison may yield a determination that the planned path 110 coincides with the most probable path of the one or more learned paths 112.

In some embodiments, the comparison module 114 may generate and/or determine a score or a value that may indicate whether the machine 102 may be travelling along a known, optimized, or good path. In some embodiments, a known, optimized, or good path may indicate that the planned path 110 may coincide with one or more learned paths 112 that may have been taken by one or more past machines navigating the same portion of the environment. In some embodiments, a good path may be the most likely path based on probabilities associated with the learned path data corresponding to the one or more learned paths 112. In some embodiments, for example, some deviation from the most likely path may result in a slightly lower score as compared with a score corresponding to a planned path 110 that may coincide with the most likely path associated with the learned path data. Correspondingly, in some embodiments, significant deviation from the most likely path may result in a significantly lower score as compared with a score corresponding to a planned path 110 that may coincide with the most likely path associated with the learned path data. Additionally or alternatively, in some embodiments, the score or value may be the same for any path that may have been travelled previously.

For example, the learned path data corresponding to the one or more learned paths 112 may indicate that, with a particular starting position, the most likely path is a first path through the portion of the environment (e.g., 75% of machines navigate the portion of the environment using the first path). Continuing the example, the learned path data corresponding to the one or more learned paths 112 may additionally indicate that, with the particular starting position, the second most likely path is a second path through the portion of the environment (e.g., 25% of machines navigate the portion of the environment using the second path). In this example, the risk to the machine is the same taking the first path as it is taking the second path. Further continuing the example, as long as the planned path 110 coincides with either the first path or the second path, the score and/or value assigned may be the same.

In some embodiments, the comparison module 114 may be configured to compare the one or more planned paths 110 with the most probable path taken based on the current trajectory 108 of the machine 102. In some embodiments, the comparison module 114 may be configured to compare the one or more planned paths 110 with multiple potential learned paths 112. For example, the one or more learned paths 112 may include several paths that may be taken from a first position to a second position and the one or more planned paths 110 may be compared with the multiple learned paths 112.

In some embodiments, the comparison module 114 may generate and/or determine whether one or more notifications 116 may be sent to the machine 102 based on the comparison between the current trajectory 108 and/or the planned paths 110 with the one or more learned paths 112. In some embodiments, the one or more notifications 116 may be generated and/or determined based on one or more differences between the current trajectory 108 and/or planned paths 110 and the one or more learned paths 112. Additionally or alternatively, the one or more notifications 116 may be generated and/or determined based on the differences being larger than a particular threshold (e.g., based on one or more heuristic analyses and/or one or more differences known a priori, etc.).

In some embodiments, the one or more notifications 116 may simply communicate that one or more differences exist between the planned paths 110 and the one or more learned paths 112. Additionally or alternatively, the one or more notifications 116 may include other path data corresponding to the one or more learned paths 112. For example, the one or more notifications 116 may indicate one or more suggested paths that may be different from the planned path 110 of the machine 102.

In some embodiments, the one or more notifications 116 may include one or more control commands to alter one or more movement characteristics corresponding to the machine 102, such as, for example, control commands that may result in decelerating, accelerating, turning, changing lanes, performing one or more evasive maneuvers, etc. corresponding to the machine 102.

In some embodiments, the one or more notifications 116 may include a score or value that may indicate a rating of the current path of the machine 102. For example, the edge server 104 may send a probability value indicating whether the machine 102 is travelling along a known, optimized, or good path, and/or may send-such as when the machine 102 is determined to not be on a known path-information on changes or updates to the path that may put the machine 102 on a more optimal path, e.g., a safer, faster, more traversed path. In some embodiments, reference to a “safer” path may indicate that the probability of increased risk to the machine, pedestrians, other people, property, etc. is lower than one or more other paths. In some embodiments, a path may be determined to be safer based on past path data corresponding to the portion of the environment. For example, in the context of a particular stretch of road including a first path and a second path, both having been traversed by one hundred (100) machines, five (5) of the one hundred (100) machines may have been damaged, passengers injured, pedestrians injured, etc. taking the first path. In comparison, one (1) of the one hundred (100) machines may have been damaged, passengers injured, pedestrians injured, etc. taking the second path. It may be determined, in this example, that the second path may be safer than the first path. In some embodiments, one or more learned paths 112 may be determined to be safer based on other criteria such as, for example, severity of damage incurred, frequency of damage incurred, paths that may not follow rules and/or norms of the traffic medium, etc.

In some embodiments, the one or more notifications 116 may include information corresponding to one or more other machines and/or planned path information corresponding to one or more other machines. For example, one or more other machines may be navigating the environment along with the machine 102. Continuing the example, the planned paths and/or other movement information corresponding to the one or more other machines may be communicated to and/or otherwise obtained by the edge server 104. Further continuing the example, the one or more notifications 116 may include the planned paths and/or other movement information corresponding to the one or more other ego-machines. In some instances, the one or more notifications 116 may indicate that the planned path of the ego-machine may intersect or come within a threshold distance of one or more paths corresponding to one or more other machines in the environment.

In some embodiments, the one or more notifications 116 may include a critical alert if the machine 102 is travelling on a path that may result in a high level of risk. For example, the one or more notifications 116 may alert the machine 102 in instances where the machine 102 is travelling against the expected flow of traffic, is in a wrong lane, is travelling too fast for a particular maneuver (e.g., turn, lane change, etc.) associated with a planned path 110, etc. In some embodiments, the high level of risk may be determined a priori and/or based on one or more heuristic analyses.

In some embodiments, the one or more notifications 116 may include one or more known safe paths which may include paths that are clear and/or paths that avoid accidents or other dangerous portions of the environment. In some embodiments, the one or more safe paths may be programmed into the edge server 104, for example, when construction is set to begin so that the one or more notifications 116 may include safe paths around the planned construction. In some embodiments, the one or more notifications 116 may include avoiding one or more known unsafe paths which may include, for example, paths that may be in an opposite direction to one or more learned paths 112. Additionally or alternatively, unsafe paths may include paths that may not follow the rules of the traffic medium. For example, in the context of a vehicle travelling on the road, a path that may include an illegal U-turn may be considered unsafe. In some embodiments, paths may be considered safe or unsafe based on the machine (e.g., the type of machine 102). For example, different rules, norms, paths, etc. may be considered for motorcycles as opposed to cars or trucks.

In some embodiments, in response to the one or more notifications 116 and/or comparison between the one or more planned paths 110 and the one or more learned paths 112, the machine 102 may perform one or more operations to navigate through the portion of the environment. In some embodiments, the one or more operations may be to continue with the planned path 110. In some embodiments, the one or more operations may alter one or more behaviors of the machine 102. For example, the one or more notifications 116 may indicate to the machine 102 to weigh perception systems associated with the machine 102 more heavily than the planned path 110.

In some embodiments, in the context of the machine 102 including an ego-machine navigating a portion of the environment, in response to receiving one or more notifications 116, the ego-machine may be configured to “return to ego.” For example, the ego-machine may be configured to weigh sensor data and/or data corresponding to a perception system more heavily than data corresponding to the one or more planned paths 110. For example, the ego-machine may have determined a planned path 110 to navigate through a particular junction; however, due to some unforeseen circumstance (an accident, traffic, poor road conditions, etc.), one or more other machines may have taken a different path through the particular portion of the environment as compared to the particular planned path 110 of the ego-machine. In response to a difference between the particular planned path 110 and the one or more past paths taken by one or more other machines, the ego-machine may receive one or more notifications 116. In response to the one or more notifications 116, the ego-machine may alter the particular planned path 110 to coincide with the past paths taken by the one or more past machines. Additionally or alternatively, in response to the one or more notifications 116, the ego-machine may weigh sensor data corresponding to one or more sensors more heavily than the planned path 110 which may result in relying more heavily on the sensor data and/or other perception systems to navigate the portion of the environment.

In some embodiments, the behavior of neighboring vehicles and/or machines may also be modified. In some embodiments, one or more machines which are identified by the edge server 104 as being within a certain proximity to the machine 102, having crossing paths with the machine 102, being in the same lane as the machine 102, and/or have a high likelihood of being impacted by the machine 102 may be warned (e.g., sent a message) and may use this information to amend their plans or paths, enter a safety mode (e.g., a pre-collision mode), lower their speed, etc.

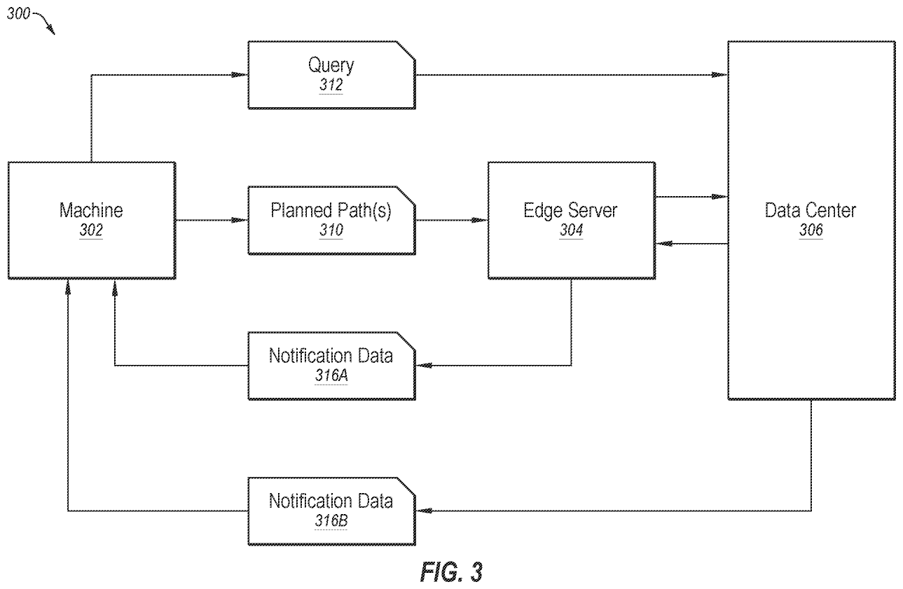

In some embodiments, in response to the one or more notifications 116, the machine 102 may be configured to request information from one or more other servers, systems, etc. such as, for example, a data center to navigate the portion of the environment. In some embodiments, the machine 102 may be configured to make one or more control determinations based on sensor data, data stored on and/or accessible by an edge server 104, and/or data stored on and/or accessible by a data center. In some embodiments, the machine-based determinations are tested against edge server data and/or logic and further both against data center data and/or higher logic if necessary. The determinations tested against one or more levels of higher logic may incorporate hierarchical decision making in one or more control determinations made by the machine 102. In some embodiments, the hierarchical decision-making with respect to, for example, the data center may be described and/or illustrated further in the present disclosure, such as, for example, with respect to FIG. 3. In some embodiments, the alert or notification 116 from the edge server 104 may be evaluated locally at the machine 102 or remotely at the edge server 104 to determine the updates to the plan or path or the machine 102.

Modifications, additions, or omissions may be made to FIG. 1A without departing from the scope of the present disclosure. For example, the number of machines 102 may vary, the number of planned paths 110, the number of edge servers 104, the number of comparison modules 114, and/or the number and type of notifications 116 may vary. The specifics given and discussed are to help provide explanation and understanding of concepts of the present disclosure and are not meant to be limiting.

FIG. 2 illustrates an environment 200 including an edge server 204 configured to generate learned path data corresponding to one or more learned paths 214, in accordance with one or more embodiments of the present disclosure. In some embodiments, the edge server 204 may include one or more servers, edge computing servers, edge nodes, etc. that may be located closer to one or more devices, systems, machines, vehicles, etc. as compared to one or more centralized servers, cloud servers, etc.

In some embodiments, the edge server 204 may be located close to an environment or portion of an environment through which one or more machines may navigate, such as, for example, the machine 102 described and/or illustrated further in the present disclosure, such as, for example, with respect to FIG. 1A. In some embodiments, the edge server 204 may be selected and/or determined using, for example, the machine 102 based on the proximity of the edge server 204 to the area that may be navigated by the machine (e.g., the machine 102).

In some embodiments, the edge server 204 may be configured to determine, using a neural network 206, one or more learned paths 214 based on past path data 210 and/or environmental data 212. In some embodiments, the edge server 204 may be an example of and/or analogous to the edge server 104 described and/or illustrated further in the present disclosure, such as, for example, with respect to FIG. 1A.

The neural network 206 may include one or more optimization algorithms, one or more machine learning systems and/or models, and/or one or more neural networks (e.g., recurrent neural networks (RNNs), temporal-based neural networks, convolutional neural networks (CNNs), generative neural networks, large language models (LLMs), transformer models, and/or other types of neural networks).

In some embodiments, the neural network 206 may include code and routines configured to allow a computing system to perform one or more operations. Additionally or alternatively, the neural network 206 may be implemented using hardware including one or more processors, CPUs, (GPUs), DPUs, PPUs, microprocessors (e.g., to perform or control performance of one or more operations), FPGAs, ASICs, accelerators (e.g., DLAs), and/or other processor types. In these and other embodiments, the neural network 206 may be implemented using a combination of hardware and software. In the present disclosure, operations described as being performed by the neural network 206 may include operations that the neural network 206 may direct a corresponding computing system to perform. In these or other embodiments, the neural network 206 may be implemented by one or more computing devices, such as that described in further detail with respect to FIGS. 5A-5D, 6, and/or 7.

In some embodiments, the neural network 206 associated with the edge server 204 may be configured to generate and/or determine learned path data correspond to one or more learned paths 214 corresponding to an environment and/or a portion of an environment based on the past path data 210, and/or the environmental data 212.

In some embodiments, the past path data 210 may include movement data and/or characteristics associated with multiple machines that may traverse a portion of an environment. The movement data and/or characteristics that may be included in the past path 210 data may include, for example, position data, orientation data, velocity data, acceleration data, jerk data, and/or other data associated with movement of the one or more machines through the portion of the environment.

In some embodiments, the past path data 210 may include data corresponding to an amount of time taken to traverse the portion of the environment. For example, in the context of the portion of the environment including a particular stretch of road, e.g., from position A to position B, the past path data 210 may include an amount of time it takes for a vehicle to travel from position A to position B. In instances where time data is not included in the past path data 210, the neural network 206 may be configured to determine the amount of time taken based on other data—e.g., position data associated with the one or more machines that may have traversed the particular portion of the environment (e.g., the particular stretch of road).

In some embodiments, multiple machines may include hundreds, thousands, tens-of thousands, etc. of machines that may navigate through the portion of the environment. In some embodiments, past path data 210 may include data transmitted by one or more machines after having travelled through the portion of the environment. For example, again in the context of the portion of the environment including a stretch of road from point A to point B, a vehicle may travel on a particular path from point A to point B and, after having travelled from point A to point B, the vehicle may transmit the corresponding path data to the edge server 204 and/or the neural network 206.

Additionally or alternatively, the past path data 210 may include movement data (e.g., position data, orientation data, velocity data, acceleration data, etc.) that may be received in real time or near real time (e.g., within seconds or fractions of a second) by the edge server 204 and/or the neural network 206. For example, a vehicle may transmit real-time position data, velocity data, etc. to the edge server 204 and/or the neural network 206 which travelling from point A to point B. In some embodiments, the neural network 206 may be configured to aggregate and store the movement data corresponding to multiple machines, the aggregated and stored movement data may be collectively referred to as the past path data 210.

In some embodiments, the past path data 210 may be received or otherwise obtained from the machines that traverse the portion of the environment. Additionally or alternatively, the past path data 210 may be received or otherwise obtained from one or more other systems, machines, collection of systems, etc. For example, in the context of the portion of the environment corresponding to a junction or section of road, the junction or section of road may be monitored by an external camera and/or other sensor (e.g., surveillance cameras, CTV cameras, RADAR sensors, LiDAR sensors, smart cities cameras, etc.). Continuing the example, the external camera(s) may be configured to generate and/or collect data corresponding to one or more machines (e.g., machines that may not be configured to transmit their own movement data). For example, the external camera(s) may collect position data corresponding to vehicles travelling through the portion of the environment. Further continuing the example, the external camera(s) may be configured to send the data to the edge server 204 and/or the neural network 206. In some embodiments, the data may be used to calculate the paths of vehicles which do not have autonomous driving capabilities and/or are not configured to share the data and/or information corresponding to the vehicle. Additionally or alternatively, the data and/or information may augment or add to the data provided by vehicles that are configured to communicate directly with the edge server(s) 204.

In some embodiments, past path data 210 corresponding to one or more other ego-machines, systems, smart-city infrastructure, etc. may be received by the edge server 204 and/or the neural network 206. In some embodiments, a comparison analysis may be performed to ensure that past path data 210 corresponding to a particular machine may not be transmitted both by the particular machine and one or more other machines, systems, etc. For example, one or more autonomous vehicles may be configured to transmit position data to, for example, the edge server 204. Continuing the example, one or more other systems may also track the position data, orientation data, acceleration data, velocity data, etc. corresponding to the same autonomous vehicle. A comparison analysis may be performed such that overlapping information corresponding to the one or more autonomous vehicles may not inform and/or distort the neural network 206 in generating learned path data corresponding to one or more learned paths 214.

In some embodiments, the past path data 210 may be collected based on successful traversals of the portion of the environment. Additionally or alternatively, the past path data 210 may include data corresponding to both successful traversals and unsuccessful traversals of the portion of the environment. For example, the past path data 210 may include data that may be collected with respect to vehicles that may have broken down or that may have gotten into an accident or were otherwise unable to travel from point A to point B in a threshold amount of time.

In some embodiments, the neural network 206 may additionally be configured to receive and/or otherwise obtain environmental data 212. The environmental data 212 may include data corresponding to the portion of the environment through which one or more machines may travel. In some embodiments, the environmental data 212 may include weather data, temperature data, humidity data, wind conditions, sound levels, and/or other data corresponding to environmental conditions that may affect one or more paths of machines through the portion of the environment.

In some embodiments, the environmental data 212 may include data indicating one or more obstructions, obstacles, or difficult areas corresponding to the portion of the environment through which one or more machines may travel. For example, the environmental data 212 may include road conditions (e.g., potholes, speedbumps, dips, etc.), construction and/or scheduled construction, barriers, fallen obstacles, and/or other objects in the environment that may affect one or more machines in navigating the portion of the environment.

In some embodiments, using the past path data 210 and/or the environmental data 212, the neural network 206 may determine and/or generate learned path data corresponding to one or more learned paths 214, the one or more learned paths 214 may indicate respective probabilities that a machine may take a given path to navigate the portion of the environment. In some embodiments, the one or more learned paths 214 may be analogous to the one or more learned paths 212 described and/or illustrated further in the present disclosure, such as, for example, with respect to FIG. 1A.

In some embodiments, the one or more learned paths 214 may include data that may be aggregated to form, for example, a 4-dimensional data set of the probability, p, that a machine is at a particular position (e.g., (x, y)) at time, r, after entering the portion of the environment. In some embodiments, the one or more learned paths 214 may be determined using one or more clustering techniques. For example, the neural network 206 may use a number of algorithms, such as, for example, k-means clustering, hierarchical clustering, mean shift clustering, agglomerative clustering, and/or other algorithms that may be configured to determine one or more probabilities that one or more paths may be taken through a particular portion of the environment.

In some embodiments, the one or more learned paths 214 may be updated dynamically (e.g., after each traversal, every five traversals, every one hundred traversals, etc.), periodically (e.g., one a month, once a year, etc.), temporarily, and/or otherwise. For example, the one or more learned paths 214 may be updated on a temporary basis to account for construction, lane blockage, or traffic easing measures, such as for high occupancy vehicle lanes by correlating paths to time of day, weather, etc., or looking at changes over the previous hour, day, week, and/or month.

Modifications, additions, or omissions may be made to FIG. 2 without departing from the scope of the present disclosure. For example, the number of edge servers 204 may vary, the number and/or type of neural networks 206 may vary, the amount of past path data 210 and/or environmental data 212 may vary, the learned paths 214 may vary, etc. The specifics given and discussed are to help provide explanation and understanding of concepts of the present disclosure and are not meant to be limiting.

FIG. 3 illustrates an environment 300 including a machine 302 configured to compare one or more planned paths 310 against notification data 316, in accordance with one or more embodiments of the present disclosure. In some embodiments, the machine 302 may be an example of and/or analogous to the machine 102 described and/or illustrated further in the present disclosure, such as, for example, with respect to FIG. 1. Further, the environment may include an edge server 304 and/or a data center 306.

In some embodiments, the edge server 304 may be an example of and/or analogous to the edge server 104 and/or the edge server 204 that may be described and/or illustrated further in the present disclosure, such as, for example, with respect to FIGS. 1A and/or 2. In some embodiments, the edge server 304 may be configured to communicate data and/or information that may correspond to one or more other machines that may be located in and/or navigating the environment. In some embodiments, the edge server 304 and/or data associated therewith may be communicated to one or more ego-machines in addition to one or more other machines to facilitate safe navigation of a particular environment and/or portion of the environment. For example, one or more ego-machines may navigate an environment that may include one or more railroads, trains, trams, airplanes, and/or other large transportation vehicles. In some embodiments, the edge server 304 may be used to facilitate communication between the ego-machine and one or more planned paths associated with the other transportation vehicles (e.g., airplanes, trains, trams, trucks, robots, etc.).

For example, an ego-machine may navigate a particular environment that may include travelling across an open railway where a train may navigate. Continuing the example, the edge server 304 may communicate path information corresponding to the train (e.g., position, orientation, time, velocity, and/or other movement information) with the ego-machine. Further, the edge server 304 may be configured to generate one or more notifications (e.g., the notification 316A) in instances where the planned path of the ego-machine may intersect with or come within a threshold distance of intersecting with the planned path of the train. In some embodiments, the ego-machine may therefore be configured to adjust a planned path based on the path information corresponding to the train.

In another example, in the context of the edge server 304 being located in or around an airport taxiway, one or more service machines may be configured to communicate with the edge server 304 which may also receive information corresponding to one or more airplanes. For example, the information may include data regarding which airplanes may takeoff or land, particular locations where the airplanes may plan to be, and/or at particular times and/or other movement characteristics (e.g., position, orientation, velocity, acceleration, etc.) associated with airplanes located in or around the airport taxiway. In instances where planned paths of the one or more service machines and one or more of the airplanes may intersect and/or come within a threshold distance of intersecting, the edge server 304 may be configured to communicate a notification and/or data indicating the planned paths to the one or more service machines. In some embodiments, this embodiment of hierarchical communication may facilitate safe navigation of the airfield and may facilitate path information communication between the service vehicles and airplanes, for example.

In some embodiments, placement of edge servers 304 may be performed based on analyzing traffic flow, cellular or other network strength, complexity of the junctions or road sections in a serviced area, volume of traffic, etc. In some embodiments, for example, one or more edge servers 304 may be configured to communicate with one or more machines navigating a particular environment. Further, some environments may use one or more edge servers 304 to help facilitate safe navigation of the environment. In some embodiments, for example, high traffic areas and particularly complex junctions may benefit from using one or more edge servers 304 (e.g., using edge servers 304 in high traffic areas may reduce the number of accidents, injuries, etc.). Additionally or alternatively, the placement of the edge servers 304 may further reduce latency in communications between vehicles and the edge server 304 and will thus result in increased safety and improved navigation.

For example, in response to one or more junctions and/or particular stretches of road including a high amount of traffic, one or more edge servers 304 may be placed nearby to facilitate communication with one or more vehicles included in the traffic. Continuing the example, by placing one or more edge servers in locations with particularly complex junctions and/or stretches of road with high amounts of traffic relative to one or more other locations and/or stretches of road, the edge server(s) 304 may be used to decrease traffic and/or facilitate safe navigation of the particular junction and/or stretch of road. Furthermore, in response to the edge server 304 being physically located in closer proximity to the vehicles navigating the particular stretch of road and/or junction, the edge server 304 may be configured to communicate with one or more vehicles navigating the particular junction and/or stretch of road in a more efficient and faster manner than, for example, one or more cloud servers.

As an additional example, placement of the edge server may be based on network strength. In some embodiments, the one or more edge servers 304 may be placed in locations where network strength may be strong enough for one or more machines to communicate with the edge server 304.

In some embodiments, the data center 306 may include one or more centralized servers, equipment, storage systems, networks, cloud servers, etc. In some embodiments, the data center 306 may include one or more servers that may be located farther from the machine 302 as compared to the location of the edge server 304. In some embodiments, the data center 306 may include one or more other edge servers located farther from the machine 302 than the edge server 304. In some embodiments, the data center 306 may include data from any number of edge servers may be shared with the data center 306 to analyze traffic flow throughout a designated region or city. In some embodiments, the data center 306 may be a distributed system. For example, multiple edge servers may be communicatively coupled to make up the data center 306.

In some embodiments, the machine 302 may be configured to generate and/or determine planned path data corresponding to one or more planned paths 310 with which the machine 302 may travel across a particular environment and/or portion of an environment. In some embodiments, the one or more planned paths 310 may be the same as and/or analogous to, the planned path(s) 110 described and/or illustrated further in the present disclosure, such as, for example, with respect to FIG. 1A. In some embodiments, the machine 302 may be configured to transmit and/or otherwise communicate planned path data corresponding to the one or more planned paths 310 to the edge server 304. As used herein, reference to the one or more planned paths 310 may also reference all of or a portion of the planned path data that may correspond to the one or more planned paths 310.

In some embodiments, the edge server 304 may be configured to store, access, manipulate, and/or otherwise use the planned path data corresponding to the one or more planned paths 310. In some embodiments, the edge server 304 may be configured to compare the planned path 310 with one or more learned paths corresponding to the portion of the environment through which the machine 302 may travel. In some embodiments, the comparison between the one or more planned paths 310 and the one or more learned paths may include a comparison between all of and/or a portion of the planned path data and the learned path data corresponding to the planned path(s) 310 and/or the learned path(s), respectively. The one or more learned paths may be the same as the one or more learned paths 114 and/or learned paths 214 described and/or illustrated further in the present disclosure, such as, for example, with respect to FIGS. 1A, 1B, 1C, and/or 2.

In some embodiments, in response to the comparison between the one or more planned paths 310 and/or the one or more learned paths 214, the edge server 304 may be configured to send notification data 316A to the machine 302. In some embodiments, the notification data 316A may include information and/or data indicating that the one or more planned paths 310 may be different from the one or more learned paths. Further, the notification data 316A may include one or more control commands that may change one or more behaviors of the machine 302 (e.g., accelerate, decelerate, turn, alter the planned path 310, perform one or more evasive maneuvers, etc.). In these or other embodiments, the notification data 316A may be the same as and/or analogous to the one or more notifications 116 described and/or illustrated further in the present disclosure, such as, for example, with respect to FIG. 1A.

In some embodiments, in response to the notification data 316A, the machine 302 may be configured to generate one or more queries 312 to request information from one or more other servers, systems, etc. such as, for example, the data center 306 to navigate the portion of the environment. In some embodiments, the one or more queries 312 may include the one or more planned paths 310 and/or the one or more notifications 316A that may include information stored on and/or otherwise accessible by the edge server 304.

In some embodiments, the data center 306, in response to the one or more queries 312, may be configured to generate notification data 316B that may indicate that the one or more planned paths 310 may coincide with data and/or information corresponding to the portion of the environment that may be stored on and/or otherwise accessible by the data center 306. For example, the data center 306 may have access to information that the portion of the environment may be partially or completely closed, as a result, the one or more planned paths 310 may not coincide with learned path data corresponding to one or more learned paths at the edge server 304 but may coincide with proper detour data and/or information that may be accessible by the data center 306. Additionally or alternatively, the notification data 316B may indicate that the one or more planned paths 310 may not coincide with any data and/or information that may correspond to the portion of the environment. As a result, the notification data 316B may indicate that the one or more planned paths 310 may be incorrect or unsafe. In some embodiments, the notification data 316B may include data with which the machine 302 may correct the planned path and/or change one or more behaviors (e.g., accelerate, decelerate, change lanes, perform evasive maneuvers, etc.). In these or other embodiments, the notification data 316B may be analogous to the notification(s) 116 and/or the notification data 316A described and/or illustrated further in the present disclosure, such as, for example, with respect to FIGS. 1A and/or 3.

In some embodiments, the data center 306, in response to the one or more queries 312, may be configured to update information corresponding to the portion of the environment in which the machine 302 may be located. For example, the data and/or information corresponding to the queries 312 may be used to update map data corresponding to a map. For example, driving difficulty scores-such as to update a map with information about a difficulty of driving in a certain area, which may be based on the amount of compiled information that is available for that particular region.

Additionally or alternatively, the data center 306 may be configured to update the edge server 304 with data and/or information that may be included in the notification data 316B. For example, in instances where the data and/or information corresponding to the one or more queries 312 is not consistent with the data and/or information associated with the data center 306, the data center 306 may provide the data and/or information to the edge server 304. In some embodiments, in response, the edge server 304 may update the information for one or more future machines that may navigate the particular portion of the environment.

In some embodiments, the machine 302 may be configured to make one or more control determinations based on sensor data, data associated with an edge server 304, and/or data associated with a data center 306. In some embodiments, the machine-based determinations are tested against edge server data and/or logic and further both against data associated with the data center 306 and/or higher logic if necessary. The determinations tested against one or more levels of higher logic may incorporate hierarchical decision making in one or more control determinations made by the machine 302.

As an example of the hierarchical decision-making in the context of the machine 302 including an ego-machine navigating a particular stretch of a road, construction may have recently begun on a stretch of road corresponding to a portion of an environment that the machine 302 may navigate. Continuing the example, the planned path 310 corresponding to the machine 302 may be different from one or more learned paths 310 corresponding to recent data—e.g., path data from machines navigating the portion of the environment in the last 12 hours. Further, the edge server 304 may compare the planned path 310 with one or more learned paths and may indicate that a difference is present. In response, the ego-machine 302 may request information from a data center 306, the data center 306 may have access to more information such as, for example, public information indicating that construction had begun in the portion of the environment in the last 12 hours. The machine 302 may receive the information from the data center 306 and may be better equipped to navigate the portion of the environment. Further continuing the example, the edge server 304 may be updated using the machine 302 and/or the data center 306 to include information corresponding to the construction such that other machines (e.g., one or more machines that may traverse the portion of the environment at one or more future times) may be notified of the construction in the portion of the environment.

Therefore, in some embodiments, local vehicle-based decisions (Level 1) are tested against edge server (Level 2) logic and further both against data center (Level 3) logic or higher if necessary. Vehicle trajectories have been used as an example herein, but the edge server 304 comparisons may be extended to anomalies associated with robotics, aerial vehicles, general image processing, and/or any other pertinent data stream related to the operation of a machine. Further, difficult object detections may be flagged and sent via edge servers 304 to a data center 306 for analysis and incorporation-such as for neural network learning and redistribution via over-the-air (OTA) updates to vehicles.

Modifications, additions, or omissions may be made to FIG. 3 without departing from the scope of the present disclosure. For example, the number of machines 302, the number of edge servers 304, and/or the number of data centers 306 may vary. The specifics given and discussed are to help provide explanation and understanding of concepts of the present disclosure and are not meant to be limiting.

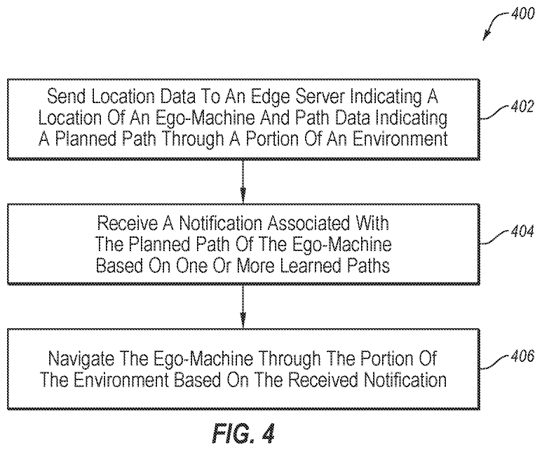

FIG. 4 is a flow diagram showing a method 400 for navigating one or more machines through a portion of an environment based on learned path data corresponding to an edge server, in accordance with one or more embodiments of the present disclosure. The method 400 may include one or more blocks 402, 404, and 406. Although illustrated with discrete blocks, the operations associated with one or more of the blocks of the method 400 may be divided into additional blocks, combined into fewer blocks, or eliminated, depending on the particular implementation.

In some embodiments, the method 400 may include block 402. At block 402, location data may be sent to an edge server. In some embodiments, the location data may indicate a location of an ego machine; for example, the current location of the ego-machine or location data that may indicate the location of the ego-machine in real time or near real time. Further, in some embodiments, the location data may include path data. In some embodiments, the path data may indicate a planned path of the machine through a portion of the environment.

At block 404, the method may additionally include receiving a notification associated with the planned path of the machine. In some embodiments, the notification may be based on one or more learned paths corresponding to the portion of the environment. In some embodiments, the notification may be based on a comparison of the planned path to one or more learned paths. In some embodiments, the one or more learned paths may be determined using the edge server based on multiple successfully navigated prior paths of one or more machines through the portion of the environment beginning at the location of the machine.

In some embodiments, the notification associated with the planned path may include data indicating a difference between the one or more learned paths and the planned path. In some embodiments, the notification may include one or more control commands altering the path of the ego-machine. Furthermore, in some embodiments, the notification may include suggested path data indicating one or more suggested paths for the ego-machine to navigate through the portion of the environment. In some embodiments, the notification may include a combination of two or more of the aforementioned examples.

In some embodiments, the successfully navigated prior paths may include one or more paths taken by one or more machines beginning at the location of the ego-machine and travelling through the portion of the environment under a time threshold.

At block 406, the ego-machine may navigate through the portion of the environment. In some embodiments, the navigation of the ego-machine may be based on the received notification, for example, from the edge server.

Modifications, additions, or omissions may be made to the method 400 and/or one or more operations included in the method 400 without departing from the scope of the present disclosure. For example, the operations corresponding to the method 400 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

### Example Autonomous Vehicle

FIG. 5A is an illustration of an example autonomous vehicle 500, in accordance with some embodiments of the present disclosure. The autonomous vehicle 500 (alternatively referred to herein as the “vehicle 500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 500 may be capable of functionality in accordance with one or more of Level 3-Level 5 of the autonomous driving levels. The vehicle 500 may be capable of functionality in accordance with one or more of Level 1-Level 5 of the autonomous driving levels. For example, the vehicle 500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 500 or other machine, such as being fully autonomous, being highly autonomous, being conditionally autonomous, being partially autonomous, providing assistive autonomy, being semi-autonomous, being primarily autonomous, or other designation.

The vehicle 500 may include components such as a chassis, a vehicle body, wheels (e.g., 2, 4, 6, 8, 18, etc.), tires, axles, and other components of a vehicle. The vehicle 500 may include a propulsion system 550, such as an internal combustion engine, hybrid electric power plant, an all-electric engine, and/or another propulsion system type. The propulsion system 550 may be connected to a drive train of the vehicle 500, which may include a transmission, to enable the propulsion of the vehicle 500. The propulsion system 550 may be controlled in response to receiving signals from the throttle/accelerator 552.

A steering system 554, which may include a steering wheel, may be used to steer the vehicle 500 (e.g., along a desired path or route) when the propulsion system 550 is operating (e.g., when the vehicle is in motion). The steering system 554 may receive signals from a steering actuator 556. The steering wheel may be optional for full automation (Level 5) functionality.

The brake sensor system 546 may be used to operate the vehicle brakes in response to receiving signals from the brake actuators 548 and/or brake sensors.

Controller(s) 536, which may include one or more CPU(s), system on chips (SoCs) 504 (FIG. 5C) and/or GPU(s), may provide signals (e.g., representative of commands) to one or more components and/or systems of the vehicle 500. For example, the controller(s) may send signals to operate the vehicle brakes via one or more brake actuators 548, to operate the steering system 554 via one or more steering actuators 556, and/or to operate the propulsion system 550 via one or more throttle/accelerators 552. The controller(s) 536 may include one or more onboard (e.g., integrated) computing devices (e.g., supercomputers) that process sensor signals, and output operation commands (e.g., signals representing commands) to enable autonomous driving and/or to assist a human driver in driving the vehicle 500. The controller(s) 536 may include a first controller 536 for autonomous driving functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. In some examples, a single controller 536 may handle two or more of the above functionalities, two or more controllers 536 may handle a single functionality, and/or any combination thereof.

The controller(s) 536 may provide the signals for controlling one or more components and/or systems of the vehicle 500 in response to sensor data received from one or more sensors (e.g., sensor inputs). The sensor data may be received from, for example and without limitation, global navigation satellite systems sensor(s) 558 (e.g., Global Positioning System sensor(s)), RADAR sensor(s) 560, ultrasonic sensor(s) 562, LIDAR sensor(s) 564, inertial measurement unit (IMU) sensor(s) 566 (e.g., accelerometer(s), gyroscope(s), magnetic compass(es), magnetometer(s), etc.), microphone(s) 596, stereo camera(s) 568, wide-view camera(s) 570 (e.g., fisheye cameras), infrared camera(s) 572, surround camera(s) 574 (e.g., 360 degree cameras), long-range and/or mid-range camera(s) 598, speed sensor(s) 544 (e.g., for measuring the speed of the vehicle 500), vibration sensor(s) 542, steering sensor(s) 540, brake sensor(s) 546 (e.g., as part of the brake sensor system 546), and/or other sensor types.

One or more of the controller(s) 536 may receive inputs (e.g., represented by input data) from an instrument cluster 532 of the vehicle 500 and provide outputs (e.g., represented by output data, display data, etc.) via a human-machine interface (HMI) display 534, an audible annunciator, a loudspeaker, and/or via other components of the vehicle 500. The outputs may include information such as vehicle velocity, speed, time, map data (e.g., the HD map 522 of FIG. 5C), location data (e.g., the location of the vehicle 500, such as on a map), direction, location of other vehicles (e.g., an occupancy grid), information about objects and status of objects as perceived by the controller(s) 536, etc. For example, the HMI display 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 500 further includes a network interface 524, which may use one or more wireless antenna(s) 526 and/or modem(s) to communicate over one or more networks. For example, the network interface 524 may be capable of communication over LTE, WCDMA, UMTS, GSM, CDMA2000, etc. The wireless antenna(s) 526 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 5B is an example of camera locations and fields of view for the example autonomous vehicle 500 of FIG. 5A, in accordance with some embodiments of the present disclosure. The cameras and respective fields of view are one example embodiment and are not intended to be limiting. For example, additional and/or alternative cameras may be included and/or the cameras may be located at different locations on the vehicle 500.

The camera types for the cameras may include, but are not limited to, digital cameras that may be adapted for use with the components and/or systems of the vehicle 500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 500 (e.g., front-facing cameras) may be used for surround view, to help identify forward-facing paths and obstacles, as well aid in, with the help of one or more controllers 536 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 570 that may be used to perceive objects coming into view from the periphery (e.g., pedestrians, crossing traffic or bicycles). Although only one wide-view camera is illustrated in FIG. 5B, there may any number of wide-view cameras 570 on the vehicle 500. In addition, long-range camera(s) 598 (e.g., a long-view stereo camera pair) may be used for depth-based object detection, especially for objects for which a neural network has not yet been trained. The long-range camera(s) 598 may also be used for object detection and classification, as well as basic object tracking.

One or more stereo cameras 568 may also be included in a front-facing configuration. The stereo camera(s) 568 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568 may be used in addition to, or alternatively from, those described herein.

Cameras with a field of view that include portions of the environment to the side of the vehicle 500 (e.g., side-view cameras) may be used for surround view, providing information used to create and update the occupancy grid, as well as to generate side impact collision warnings. For example, surround camera(s) 574 (e.g., four surround cameras 574 as illustrated in FIG. 5B) may be positioned to on the vehicle 500. The surround camera(s) 574 may include wide-view camera(s) 570, fisheye camera(s), 360-degree camera(s), and/or the like. For example, four fisheye cameras may be positioned on the vehicle's front, rear, and sides. In an alternative arrangement, the vehicle may use three surround camera(s) 574 (e.g., left, right, and rear), and may leverage one or more other camera(s) (e.g., a forward-facing camera) as a fourth surround-view camera.

Cameras with a field of view that include portions of the environment to the rear of the vehicle 500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 598, stereo camera(s) 568), infrared camera(s) 572, etc.), as described herein.

FIG. 5C is a block diagram of an example system architecture for the example autonomous vehicle 500 of FIG. 5A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 500 in FIG. 5C is illustrated as being connected via bus 502. The bus 502 may include a Controller Area Network (CAN) data interface (alternatively referred to herein as a “CAN bus”). A CAN may be a network inside the vehicle 500 used to aid in control of various features and functionality of the vehicle 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 502 is described herein as being a CAN bus, this is not intended to be limiting. For example, in addition to, or alternatively from, the CAN bus, FlexRay and/or Ethernet may be used. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the vehicle 500, and two or more busses 502 may communicate with the same components. In some examples, each SoC 504, each controller 536, and/or each computer within the vehicle may have access to the same input data (e.g., inputs from sensors of the vehicle 500), and may be connected to a common bus, such the CAN bus.

The vehicle 500 may include one or more controller(s) 536, such as those described herein with respect to FIG. 5A. The controller(s) 536 may be used for a variety of functions. The controller(s) 536 may be coupled to any of the various other components and systems of the vehicle 500 and may be used for control of the vehicle 500, artificial intelligence of the vehicle 500, infotainment for the vehicle 500, and/or the like.

The vehicle 500 may include a system(s) on a chip (SoC) 504. The SoC 504 may include CPU(s) 506, GPU(s) 508, processor(s) 510, cache(s) 512, accelerator(s) 514, data store(s) 516, and/or other components and features not illustrated. The SoC(s) 504 may be used to control the vehicle 500 in a variety of platforms and systems. For example, the SoC(s) 504 may be combined in a system (e.g., the system of the vehicle 500) with an HD map 522 which may obtain map refreshes and/or updates via a network interface 524 from one or more servers (e.g., server(s) 578 of FIG. 5D).

The CPU(s) 506 may include a CPU cluster or CPU complex (alternatively referred to herein as a “CCPLEX”). The CPU(s) 506 may include multiple cores and/or L2 caches. For example, in some embodiments, the CPU(s) 506 may include eight cores in a coherent multi-processor configuration. In some embodiments, the CPU(s) 506 may include four dual-core clusters where each cluster has a dedicated L2 cache (e.g., a 2 MB L2 cache). The CPU(s) 506 (e.g., the CCPLEX) may be configured to support simultaneous cluster operation enabling any combination of the clusters of the CPU(s) 506 to be active at any given time.

The CPU(s) 506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 508 may include an integrated GPU (alternatively referred to herein as an “iGPU”). The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power-optimized for best performance in automotive and embedded use cases. For example, the GPU(s) 508 may be fabricated on a Fin field-effect transistor (FinFET). However, this is not intended to be limiting, and the GPU(s) 508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

In addition, the GPU(s) 508 may include an access counter that may keep track of the frequency of access of the GPU(s) 508 to memory of other processors. The access counter may help ensure that memory pages are moved to the physical memory of the processor that is accessing the pages most frequently.

The SoC(s) 504 may include any number of cache(s) 512, including those described herein. For example, the cache(s) 512 may include an L3 cache that is available to both the CPU(s) 506 and the GPU(s) 508 (e.g., that is connected to both the CPU(s) 506 and the GPU(s) 508). The cache(s) 512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 504 may include an arithmetic logic unit(s) (ALU(s)) which may be leveraged in performing processing with respect to any of the variety of tasks or operations of the vehicle 500—such as processing DNNs. In addition, the SoC(s) 504 may include a floating point unit(s) (FPU(s))—or other math coprocessor or numeric coprocessor types—for performing mathematical operations within the system. For example, the SoC(s) 504 may include one or more FPUs integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 508, and by using an inference accelerator, for example, a designer may target either the DLA(s) or the GPU(s) 508 for any function. For example, the designer may focus processing of CNNs and floating point operations on the DLA(s) and leave other functions to the GPU(s) 508 and/or other accelerator(s) 514.

The accelerator(s) 514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 514 (e.g., the hardware acceleration cluster) may include a computer vision network on-chip and SRAM, for providing a high-bandwidth, low latency SRAM for the accelerator(s) 514. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to processed RADAR. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 566 output that correlates with the vehicle 500 orientation, distance, 3D location estimates of the object obtained from the neural network and/or other sensors (e.g., LIDAR sensor(s) 564 or RADAR sensor(s) 560), among others.

The SoC(s) 504 may include data store(s) 516 (e.g., memory). The data store(s) 516 may be on-chip memory of the SoC(s) 504, which may store neural networks to be executed on the GPU and/or the DLA. In some examples, the data store(s) 516 may be large enough in capacity to store multiple instances of neural networks for redundancy and safety. The data store(s) 516 may comprise L2 or L3 cache(s) 512. Reference to the data store(s) 516 may include reference to the memory associated with the PVA, DLA, and/or other accelerator(s) 514, as described herein.

The SoC(s) 504 may include one or more processor(s) 510 (e.g., embedded processors). The processor(s) 510 may include a boot and power management processor that may be a dedicated processor and subsystem to handle boot power and management functions and related security enforcement. The boot and power management processor may be a part of the SoC(s) 504 boot sequence and may provide runtime power management services. The boot power and management processor may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, and/or accelerator(s) 514. If temperatures are determined to exceed a threshold, the boot and power management processor may enter a temperature fault routine and put the SoC(s) 504 into a lower power state and/or put the vehicle 500 into a chauffeur to safe-stop mode (e.g., bring the vehicle 500 to a safe stop).

The processor(s) 510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 510 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 510 may further include a real-time camera engine that may include a dedicated processor subsystem for handling real-time camera management.

The processor(s) 510 may further include a high dynamic range signal processor that may include an image signal processor that is a hardware engine that is part of the camera processing pipeline.

The processor(s) 510 may include a video image compositor that may be a processing block (e.g., implemented on a microprocessor) that implements video post-processing functions needed by a video playback application to produce the final image for the player window. The video image compositor may perform lens distortion correction on wide-view camera(s) 570, surround camera(s) 574, and/or on in-cabin monitoring camera sensors. An in-cabin monitoring camera sensor is preferably monitored by a neural network running on another instance of the Advanced SoC, configured to identify in-cabin events and respond accordingly. In-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a mobile industry processor interface (MIPI) camera serial interface for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role.

The SoC(s) 504 may further include a broad range of peripheral interfaces to enable communication with peripherals, audio codecs, power management, and/or other devices. The SoC(s) 504 may be used to process data from cameras (e.g., connected over Gigabit Multimedia Serial Link and Ethernet), sensors (e.g., LIDAR sensor(s) 564, RADAR sensor(s) 560, etc. that may be connected over Ethernet), data from bus 502 (e.g., speed of vehicle 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks.

The SoC(s) 504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 508.

In some examples, a CNN for facial recognition and vehicle owner identification may use data from camera sensors to identify the presence of an authorized driver and/or owner of the vehicle 500. The always-on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In another example, a CNN for emergency vehicle detection and identification may use data from microphones 596 to detect and identify emergency vehicle sirens. In contrast to conventional systems, that use general classifiers to detect sirens and manually extract features, the SoC(s) 504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 562, until the emergency vehicle(s) passes.

The vehicle may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The vehicle 500 may include a GPU(s) 520 (e.g., discrete GPU(s), or dGPU(s)), that may be coupled to the SoC(s) 504 via a high-speed interconnect (e.g., NVIDIA's NVLINK). The GPU(s) 520 may provide additional artificial intelligence functionality, such as by executing redundant and/or different neural networks, and may be used to train and/or update neural networks based on input (e.g., sensor data) from sensors of the vehicle 500.

The vehicle 500 may further include the network interface 524 which may include one or more wireless antennas 526 (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 500 information about vehicles in proximity to the vehicle 500 (e.g., vehicles in front of, on the side of, and/or behind the vehicle 500). This functionality may be part of a cooperative adaptive cruise control functionality of the vehicle 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 500 may further include data store(s) 528, which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The vehicle 500 may further include GNSS sensor(s) 558. The GNSS sensor(s) 558 (e.g., GPS, assisted GPS sensors, differential GPD (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The vehicle 500 may further include RADAR sensor(s) 560. The RADAR sensor(s) 560 may be used by the vehicle 500 for long-range vehicle detection, even in darkness and/or severe weather conditions. RADAR functional safety levels may be ASIL B. The RADAR sensor(s) 560 may use the CAN and/or the bus 502 (e.g., to transmit data generated by the RADAR sensor(s) 560) for control and to access object tracking data, with access to Ethernet to access raw data, in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250 m range. The RADAR sensor(s) 560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 500 surrounding at higher speeds with minimal interference from traffic in adjacent lanes. The other two antennae may expand the field of view, making it possible to quickly detect vehicles entering or leaving the vehicle's 500 lane.

Mid-range RADAR systems may include, as an example, a range of up to 160 m (front) or 80 m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 500 may further include ultrasonic sensor(s) 562. The ultrasonic sensor(s) 562, which may be positioned at the front, back, and/or the sides of the vehicle 500, may be used for park assist and/or to create and update an occupancy grid. A wide variety of ultrasonic sensor(s) 562 may be used, and different ultrasonic sensor(s) 562 may be used for different ranges of detection (e.g., 2.5 m, 4 m). The ultrasonic sensor(s) 562 may operate at functional safety levels of ASIL B.

The vehicle 500 may include LIDAR sensor(s) 564. The LIDAR sensor(s) 564 may be used for object and pedestrian detection, emergency braking, collision avoidance, and/or other functions. The LIDAR sensor(s) 564 may be functional safety level ASIL B. In some examples, the vehicle 500 may include multiple LIDAR sensors 564 (e.g., two, four, six, etc.) that may use Ethernet (e.g., to provide data to a Gigabit Ethernet switch).

In some examples, the LIDAR sensor(s) 564 may be capable of providing a list of objects and their distances for a 360-degree field of view. Commercially available LIDAR sensor(s) 564 may have an advertised range of approximately 100 m, with an accuracy of 2 cm-3 cm, and with support for a 100 Mbps Ethernet connection, for example. In some examples, one or more non-protruding LIDAR sensors 564 may be used. In such examples, the LIDAR sensor(s) 564 may be implemented as a small device that may be embedded into the front, rear, sides, and/or corners of the vehicle 500. The LIDAR sensor(s) 564, in such examples, may provide up to a 120-degree horizontal and 35-degree vertical field-of-view, with a 200 m range even for low-reflectivity objects. Front-mounted LIDAR sensor(s) 564 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 500. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 564 may be less susceptible to motion blur, vibration, and/or shock.

The vehicle may further include IMU sensor(s) 566. The IMU sensor(s) 566 may be located at a center of the rear axle of the vehicle 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the vehicle 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include microphone(s) 596 placed in and/or around the vehicle 500. The microphone(s) 596 may be used for emergency vehicle detection and identification, among other things.

The vehicle may further include any number of camera types, including stereo camera(s) 568, wide-view camera(s) 570, infrared camera(s) 572, surround camera(s) 574, long-range and/or mid-range camera(s) 598, and/or other camera types. The cameras may be used to capture image data around an entire periphery of the vehicle 500. The types of cameras used depends on the embodiments and requirements for the vehicle 500, and any combination of camera types may be used to provide the necessary coverage around the vehicle 500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 5A and FIG. 5B.

The vehicle 500 may further include vibration sensor(s) 542. The vibration sensor(s) 542 may measure vibrations of components of the vehicle, such as the axle(s). For example, changes in vibrations may indicate a change in road surfaces. In another example, when two or more vibration sensors 542 are used, the differences between the vibrations may be used to determine friction or slippage of the road surface (e.g., when the difference in vibration is between a power-driven axle and a freely rotating axle).

The vehicle 500 may include an ADAS system 538. The ADAS system 538 may include a SoC, in some examples. The ADAS system 538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 560, LIDAR sensor(s) 564, and/or a camera(s). The ACC systems may include longitudinal ACC and/or lateral ACC. Longitudinal ACC monitors and controls the distance to the vehicle immediately ahead of the vehicle 500 and automatically adjust the vehicle speed to maintain a safe distance from vehicles ahead. Lateral ACC performs distance keeping, and advises the vehicle 500 to change lanes when necessary. Lateral ACC is related to other ADAS applications such as LCA and CWS.

CACC uses information from other vehicles that may be received via the network interface 524 and/or the wireless antenna(s) 526 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 500), while the I2V communication concept provides information about traffic further ahead. CACC systems may include either or both I2V and V2V information sources. Given the information of the vehicles ahead of the vehicle 500, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 500 if the vehicle 500 starts to exit the lane. BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s).

RCTW systems may provide visual, audible, and/or tactile notification when an object is detected outside the rear-camera range when the vehicle 500 is backing up. Some RCTW systems include AEB to ensure that the vehicle brakes are applied to avoid a crash. RCTW systems may use one or more rear-facing RADAR sensor(s) 560, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 500, the vehicle 500 itself must, in the case of conflicting results, decide whether to heed the result from a primary computer or a secondary computer (e.g., a first controller 536 or a second controller 536). For example, in some embodiments, the ADAS system 538 may be a backup and/or secondary computer for providing perception information to a backup computer rationality module. The backup computer rationality monitor may run a redundant diverse software on hardware components to detect faults in perception and dynamic driving tasks. Outputs from the ADAS system 538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 504.

In other examples, ADAS system 538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 538 may be fed into the primary computer's perception block and/or the primary computer's dynamic driving task block. For example, if the ADAS system 538 indicates a forward crash warning due to an object immediately ahead, the perception block may use this information when identifying objects. In other examples, the secondary computer may have its own neural network that is trained and thus reduces the risk of false positives, as described herein.

The vehicle 500 may further include the infotainment SoC 530 (e.g., an in-vehicle infotainment system (IVI)). Although illustrated and described as an SoC, the infotainment system may not be a SoC, and may include two or more discrete components. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 500. For example, the infotainment SoC 530 may include radios, disk players, navigation systems, video players, USB and Bluetooth connectivity, carputers, in-car entertainment, Wi-Fi, steering wheel audio controls, hands-free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the vehicle 500. In some examples, the infotainment SoC 530 may be coupled to a supervisory MCU such that the GPU of the infotainment system may perform some self-driving functions in the event that the primary controller(s) 536 (e.g., the primary and/or backup computers of the vehicle 500) fail. In such an example, the infotainment SoC 530 may put the vehicle 500 into a chauffeur to safe-stop mode, as described herein.

The vehicle 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a system diagram for communication between cloud-based server(s) and the example autonomous vehicle 500 of FIG. 5A, in accordance with some embodiments of the present disclosure. The system 576 may include server(s) 578, network(s) 590, and vehicles, including the vehicle 500. The server(s) 578 may include a plurality of GPUs 584(A)-584(H) (collectively referred to herein as GPUs 584), PCIe switches 582(A)-582(H) (collectively referred to herein as PCIe switches 582), and/or CPUs 580(A)-580(B) (collectively referred to herein as CPUs 580). The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCIe switches are illustrated, this is not intended to be limiting. Depending on the embodiment, each of the server(s) 578 may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the vehicles, image data representative of images showing unexpected or changed road conditions, such as recently commenced road work. The server(s) 578 may transmit, over the network(s) 590 and to the vehicles, neural networks 592, updated neural networks 592, and/or map information 594, including information regarding traffic and road conditions. The updates to the map information 594 may include updates for the HD map 522, such as information regarding construction sites, potholes, detours, flooding, and/or other obstructions. In some examples, the neural networks 592, the updated neural networks 592, and/or the map information 594 may have resulted from new training and/or experiences represented in data received from any number of vehicles in the environment, and/or based on training performed at a datacenter (e.g., using the server(s) 578 and/or other servers).

The server(s) 578 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 590, and/or the machine learning models may be used by the server(s) 578 to remotely monitor the vehicles.

In some examples, the server(s) 578 may receive data from the vehicles and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the vehicle 500. For example, the deep-learning infrastructure may receive periodic updates from the vehicle 500, such as a sequence of images and/or objects that the vehicle 500 has located in that sequence of images (e.g., via computer vision and/or other machine learning object classification techniques). The deep-learning infrastructure may run its own neural network to identify the objects and compare them with the objects identified by the vehicle 500 and, if the results do not match and the infrastructure concludes that the AI in the vehicle 500 is malfunctioning, the server(s) 578 may transmit a signal to the vehicle 500 instructing a fail-safe computer of the vehicle 500 to assume control, notify the passengers, and complete a safe parking maneuver.

For inferencing, the server(s) 578 may include the GPU(s) 584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point, connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, include wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail in the present disclosure) associated with a display of the computing device 600. The computing device 600 may include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, etc.), and output the data (e.g., as an image, video, sound, etc.).

### Example Data Center

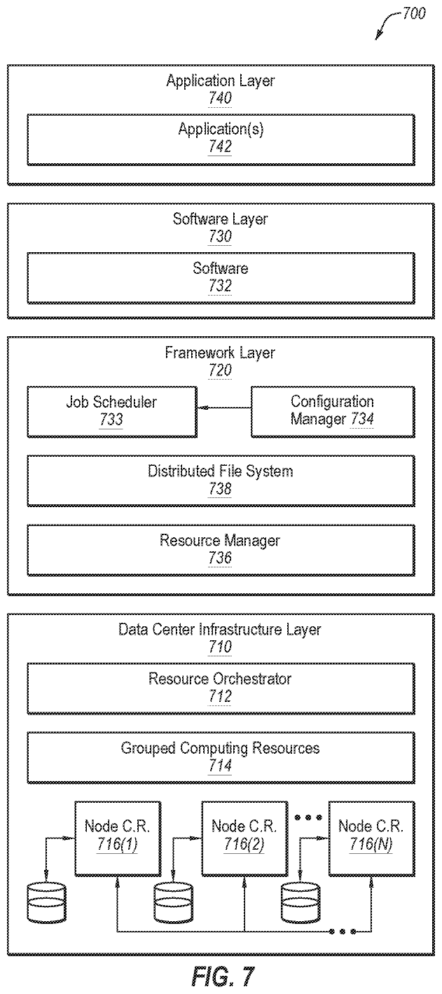

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-716(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 732, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described in the present disclosure with respect to the data center 700. In at least one embodiment, trained or deployed machine learning models corresponding to one or more neural networks may be used to infer or predict information using resources described in the present disclosure with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described in the present disclosure may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B. Additionally, use of the term “based on” should not be interpreted as “only based on” or “based only on.” Rather, a first element being “based on” a second element includes instances in which the first element is based on the second element but may also be based on one or more additional elements.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
sending, to an edge server, location data indicating a location of an ego-machine and path data indicating a planned path through a portion of an environment corresponding to the ego-machine;
receiving, from the edge server, a notification associated with the planned path of the ego-machine based at least on a comparison of the planned path to one or more learned paths, the one or more learned paths determined using the edge server and based at least on a plurality of successfully navigated prior paths of one or more other machines through the portion of the environment including the location of the ego-machine;
navigating the ego-machine through the portion of the environment based at least on the received notification.

2. The method of claim 1, wherein the notification associated with the planned path includes one or more of:
data indicating a difference between the one or more learned paths and the planned path;
one or more control commands altering the path of the ego-machine; or
suggested path data indicating one or more suggested paths for the ego-machine to navigate through the portion of the environment.

3. The method of claim 1, further comprising:
requesting information associated with the portion of the environment from a data center;
obtaining the information associated with the portion of the environment from the data center; and
navigating the ego-machine through the portion of the environment based at least on the received notification and the obtained information.

4. The method of claim 1, wherein the plurality of successfully navigated prior paths include paths taken by a plurality of machines through the location of the ego-machine and travelling through the portion of the environment under a time threshold.

5. The method of claim 1, wherein the ego-machine is a first ego-machine, and the one or more learned paths are determined based on one or more respective probabilities, the one or more respective probabilities indicating a likelihood that a second ego-machine with a same location as the location of the first ego-machine navigates the portion of the environment using a particular path.

6. The method of claim 1, wherein the portion of the environment describes an area or a volume.

7. The method of claim 1, wherein the one or more learned paths are determined using one or more machine learning models, neural networks, deep neural networks, or optimization algorithms.

8. The method of claim 1, further comprising, prior to sending location data indicating a location of an ego-machine:
determining the edge server from a plurality of edge servers with which to communicate based on the location of the ego-machine.

9. An edge server comprising:
one or more processors comprising processing circuitry to perform operations comprising:
receiving, from a machine, location data indicating a location of the machine and path data indicating a planned path corresponding to the machine from the location of the machine through a portion of an environment;
comparing the path data to learned path data, the learned path data indicating one or more learned paths corresponding to a probability of successful traversal of a plurality of prior machines across a plurality of prior paths through the portion of the environment; and
sending information about the path data based at least on the comparison between the path data and the learned path data.

10. The edge server of claim 9, wherein the information about the planned path includes one or more of:
data associated with a notification, the notification indicating a difference between the one or more learned paths and the planned path;
one or more control commands altering the planned path of the machine; or
suggested path data indicating one or more suggested paths for the machine to navigate through the portion of an environment.

11. The edge server of claim 9, wherein the machine is a first machine, and the one or more learned paths are determined based on one or more respective probabilities, the one or more respective probabilities indicating a likelihood that a second machine with a same location as the location of the first machine navigates the portion of an environment using a particular path.

12. The edge server of claim 9, wherein the portion of an environment describes an area or a volume.

13. The edge server of claim 9, wherein the one or more learned paths are determined using one or more machine learning models, neural networks, deep neural networks, or optimization algorithms.

14. The edge server of claim 9, wherein the one or more processors correspond to at least one of:
a control system for an autonomous or semi-autonomous machine;
a perception system for an autonomous or semi-autonomous machine;
a system for performing one or more simulation operations;
a system for performing digital twin operations;
a system for performing light transport simulation;
a system for performing collaborative content creation for 3D assets;
a system for performing one or more deep learning operations;
a system for generating or presenting at least one of augmented reality content, virtual reality content, or mixed reality content;
a system for hosting one or more real-time streaming applications;
a system implemented using an edge device;
a system implemented using a robot;
a system for performing one or more conversational AI operations;
a system implementing one or more language models;
a system implementing one or more large language models (LLMs);
a system for performing one or more generative AI operations;
a system for generating synthetic data;
a system incorporating one or more virtual machines (VMs);
a system implemented at least partially in a data center; or
a system implemented at least partially using cloud computing resources.

15. A method comprising:
receiving suggested path data indicating a path used by a machine to navigate through a portion of an environment;
comparing the suggested path data to planned path data, the planned path data indicating a planned path for the machine through the portion of the environment; and
navigating the machine through the portion of the environment based on the comparison.

16. The method of claim 15, further comprising:
requesting information associated with the portion of the environment from a data center;
obtaining the information associated with the portion of the environment from the data center; and
navigating the machine through the portion of the environment based at least on the comparison and the obtained information.

17. The method of claim 15, wherein the suggested path data is determined using a plurality of successfully navigated prior paths include paths taken by a plurality of machines through a location of the machine and navigating through the portion of the environment under a time threshold.

18. The method of claim 15, wherein the machine is a first ego-machine, and the suggested path data is determined based on one or more respective probabilities, the one or more respective probabilities indicating a likelihood that a second ego-machine with a same location as the location of the first ego-machine navigates the portion of the environment using a particular path.

19. The method of claim 15, wherein the portion of the environment describes an area or a volume.

20. The method of claim 15, wherein the suggested path data is determined using one or more machine learning models, neural networks, deep neural networks, or optimization algorithms.
